(19) United States
(12) Patent Application Publication
(10) Pub. No.: US 2017/0243242 A1
(43) Pub. Date: Aug. 24, 2017

(54) SYSTEMS AND METHODS FOR ADDING FUNCTIONALITY TO MERCHANT SALES AND FACILITATING DATA COLLECTION

(71) Applicant: COZUMU INC., Toronto (CA)

(72) Inventors: GARY CHAIKIN, Toronto (CA); JONATHAN HOBBS, Dunrobin (CA)

(21) Appl. No.: 15/588,327

(22) Filed: May 5, 2017

Related U.S. Application Data
(63) Continuation of application No. 13/076,012, filed on Mar. 30, 2011.
(60) Provisional application No. 61/319,905, filed on Apr. 1, 2010.
(60) Provisional application No. 61/453,606, filed on Mar. 17, 2011.

(51) Int. Cl. G06Q 30/02; G06K 7/14; G06Q 20/20; G06K 19/06; G06Q 20/32

(52) U.S. Cl. CPC G06Q 30/0238; G06K 19/06112; G06Q 20/322; G06Q 20/204; G06K 7/1417; G06K 19/06028

(57) ABSTRACT

Embodiments of the invention provide systems, methods and devices for adding functionality to merchant sales and facilitating data collection, including: a central server for hosting content and applications, mobile devices to access said applications and interact with electronic content, and on-site devices functioning as processing and communication equipment. All of which allows advertisers to offer customized incentives, provides merchants visibility into product flow and customer behavior, and makes available to customers an electronic mobile wallet. The integrated network functions on a real-time basis, providing instant updates, billing, inquiries, sales processing, inventory tracking, and more.

### PRIORITY CLAIM

The present application is a continuation application of U.S. application Ser. No. 13/076,012 filed Mar. 30, 2011 which is presently pending. U.S. application Ser. No. 13/076,012 and the present application claim benefit under 35 USC Section 119(e) of U.S. Provisional Patent Application Ser. No. 61/319,905 filed on 1 Apr. 2010 by Gary Chaikin and Jonathan Hobbs, and U.S. Provisional Patent Application Ser. No. 61/453,606 filed on 17 Mar. 2011 by Gary Chaikin and Jonathan Hobbs. The present application is based on and claims priority from these applications, the disclosures of which are hereby expressly incorporated herein by reference.

### BACKGROUND

Providing coupons or “money-off” offers to customers is a longtime marketing technique to encourage customer loyalty and encourage customers to purchase new products. For many years the norm has been to distribute coupons in paper form through direct mail or direct means. The coupon would be cropped from the surrounding advertisement, taken to the participating merchant and presented with a plurality of coupons upon check-out.

Such an arcane method of incentivizing customers has many disadvantages. Firstly, a coupon not used is money wasted by the advertiser, as well as paper resources wasted. Money is lost when the advertiser paid for the production and the distribution of coupons not redeemed, which is usually the case. Additionally, it is difficult and time consuming to customize physical coupons for distribution to specific user groups; even so the probability that one coupon will reach the demographic group of interest is low. Lastly, and not least, are the hassles incurred by the customer and merchant during checkout: wherein the physical coupons are presented to the cashier, and one-by-one each coupon is checked for expiration and either manually entered into the register or scanned into the point-of-sale system. Some of the disadvantages above have been addressed with print-at-home coupons. Still, the physical coupon remains more of a hindrance than an incentive to business.

In recent times online incentives have been developed with the introduction and success of e-commerce, commonly referred to as promo codes during the online checkout process. When compared to the physical coupons, there are no costs associated with production and distribution. As well, slowing down the check-out process is no longer of concern. But the obvious short-fall here is that coupons for e-commerce are just that, only for online purchases.

Recent technology has also allowed coupon printers and activators to be installed at retailers' point-of-sale stations. Here coupons are generated and printed based on consumer profiling. The physical coupons are provided to the customer for future purchases. This technology's falls short in that it operates on limited consumer profiling information, requires customers to handle physical coupons and prolongs the checkout process, and still requires coupon processing to occur at a later time (i.e. the technology does not operate in real-time).

Coupons are just one of the many forms of incentives for customers. Currently a method that is very popular to promote customer loyalty is for a merchant to provide a customer with a machine-readable loyalty card, also known as a membership card. Typically these cards have a magnetic strip that is read at check-out by having the user swipe their card at any time during the check-out process. After the card is read, discounts are applied to purchases and points may be added to their loyalty account to be redeemed later.

Similar to the membership cards are the very popular gift cards. Usually a gift card is redeemable at any store belonging to the merchant that issued the gift card. The card is read in a similar fashion as the membership card, either swiped through a magnetic reader or scanned with a barcode reader. The devices that process a gift card's crediting/debiting simply translate the encoded data into a numeric string that uniquely identifies the gift card and is forwarded to a remote processor for reconciliation.

Customers utilizing membership and gift cards are at an inconvenience now that such incentives are ubiquitous. Customers are required to keep on hand, usually in their wallet or purse, multiple cards for multiple merchants. It is their responsibility to track the balances on these cards and if stolen or lost, the customer pays for the unintended consequences.

Today, the ownership of mobile phones has become ubiquitous. In addition, over the years cell phones have evolved from simple devices intended to handle only voice data, into multifunctional devices capable of internet browsing, playing audio/video data, location tracking, and more. Improvements have been in all technical areas: data transfer rates, screen size and resolution, user interaction options (e.g. touch screen, accelerometer and QWERTY pads), memory, processing, etc. . . .

With these concurrent improvements it has been proposed to deliver coupons and other incentives through a user's mobile phone, allowing electronic incentives to be redeemed directly through a store's point of sale system. Because the use of a barcode scanners has become commonplace in everyday life, it further makes sense that coupons are redeemed at checkout by presenting barcodes on the screen of a mobile device to be scanned.

The term point-of-sale (POS) refers to the system used by a retailer, vendor, or merchant to process a customer's purchases. Most point of sale systems are comprised of a barcode scanner, a register, credit card payment terminal, and an onsite central processor that tracks SKU prices, descriptions, inventory, etc. . . . Today many point-of-sale systems have reached a ‘legacy’ status, having become a dated collection of equipment and associated software. Up till now, for many merchants to accommodate electronic incentives, they have to update these legacy systems. Unfortunately to update or replace such systems is expensive and troublesome. If electronic incentives are to become ubiquitous, any upgrades to POS systems needs to be low cost and easy to implement.

By solving the electronic coupon check-out process, one now needs to look at how to deliver electronic incentives to a mobile device. For the most part, mobile devices communicate through their subscriber's cellular network. These networks are notorious for charging high rates for data transfers. To simply push electronic incentives to mobile devices and to store this content locally would hinder the ubiquitous case for electronic incentives as consumers are forced to pay the high costs for data transfer. Though the cost can be deemed manageable if the coupons delivered to the user's mobile device are coupons that are certain to be redeemed. This can be accomplished by allowing users to interact with electronic incentives over web pages or software applications that utilize a remote server to host applications and databases.

Currently, web pages are often defined using Hyper Text Markup Language (HTML). New protocols for internet browsing using mobile devices exist, such as Wireless Access Protocol (WAP). WAP provides the ability to easily view web pages over a small screen, such as those found on mobile devices.

Interacting with web pages is an excellent way to gather information but a poor method of alerting users to messages or alerts. Ubiquitous today is the use of short-message-service (SMS) or multimedia messaging service (MMS). Many subscribers to cellular networks are capable of receiving these messaging services, and better yet are using these services extensively. If it's desired to send an alert to a user, for say with an attached URL, these messaging services are commonplace.

In addition to proposing the delivery of electronic coupons through mobile devices, others have proposed that these incentives are selected based on a customer's real-time location and said location's proximity to incentives in the area. This is an idea well known to those practitioners in the electronic incentive industry. There are several general ways to determine the location of a mobile device and its user. The two leading methods are Global Position System (GPS) and Cell ID, the method of triangulating nearby cell towers. GPS is a satellite based location service that relies on the user's mobile device to be equipped with GPS hardware and service. Alternatively, a third party could deliver location data using GPS (i.e. an automobile's GPS unit) to be utilized by the electronic incentive program.

Prior art that claims systems that add functionality to merchant sales through electronic incentives, fails in areas where the present invention's novel ideas exceed. Some of these areas being:

limiting data storage and processing demands on a user's mobile device, or

limiting data transfer over costly cellular networks, or

eliminating consumables (e.g. paper), or

limiting customer's need to handle, track and organize incentives, or

communicating between the point-of-sale terminals processing the electronic incentives and the remote server that distributes the incentives, or

limiting the time it takes to complete the check out process, or

creating coupon redemption codes dynamically that support the inclusion of customer specific information, or

easily allowing devices to scan the display of a mobile device, or

allowing user's of electronic incentives to interact with the distributing server, or

eliminating the need to develop software applications specific to a mobile device's architecture and operating system, or

allowing the option to bill advertisers only for incentives redeemed, or

ensuring easy to implement systems to integrate with legacy point-of-sale systems, or

ensuring redemption of only valid incentives, or

providing a central location for the collection and analysis of data.

Additionally, many of the same components in the present invention used to distribute and redeem electronic incentives are used in further embodiments as a data management system to track inventory, add visibility to store sales, better understand customer behavior, or any other use of a data utilization system.

The data management system is designed to easily integrate into current legacy data systems (e.g. point-of-sale system), or to be setup independently. The result is real-time viewing and analysis of data from multiple locations. As many business tools become data centric, there is a growing need to collect data in a centralized location for viewing and analysis. Current prior art to meet this need falls short in a number of areas, some of which being:

avoiding replacement or modifications to existing data management hardware or software; or

allowing to continue to forward data to pre-existing data utility systems; or

providing a central location for the collection and analysis of data; or

selectively deciding what data to forward to data collection.

Below is prior art of interest, explanations of their shortcomings, and explanations of how the present invention's novel ideas address these short comings.

In published US patent application 20070288310 published on Dec. 13, 2007, inventors Boos and Westerberg claim methods of doing business and a system of information distribution that relies on knowing the location or activities of a mobile device user to deliver content to said user's mobile device. The content is delivered as “data packets” to the mobile devices. US patent application 20070288310 differs from the present invention in its need to deliver content based on triggers about the user's actions or location. Wherein the patent application's methods push or forward data onto the user's mobile device; the user has limited involvement in deciding what is sent to their mobile device. Additionally, the system relies on a point-of-sale system to inform the coupon database of redemption. All of which has the disadvantage of requiring users to accept the data transfer costs and memory allocation, and relying on existing 3rd party payment networks connected to registers in order to confirm coupon redemptions.

In published U.S. Pat. No. 6,993,326, published on Jan. 31, 2006 and US Patent Applications 20020164977, published on Nov. 7, 2002 and 20090259544 published on Oct. 15, 2009, inventors Link II, Cardina, and Meadows claim methods and systems for transmitting messages over a wireless network to wireless communications devices, by storing messages in a database, wherein each stored message is associated with a location or action trigger. When that location or action is triggered, messages are transmitted to the wireless communications devices; where upon receiving an acknowledgement from the wireless communications device a receipt is provided to the advertiser. Such methods are an inconvenience to a mobile device user, wherein the user is not involved in the deciding what data is pushed onto their mobile device. In addition, there is no confirmation that the incentives were used. The methods within the prior art only go as far as requesting that the mobile device user reply with a confirmation of delivery. Such methods and systems are at the disadvantage of forcing messages onto mobile device users, requiring users to pay the data transmission costs and to allocate memory on their devices. Additionally, no systems or methods are in place to determine, with certainty, if incentives are redeemed, which doesn't allow for charging advertisers in real-time, tracking customer behavior, and more.

In published US patent Application 20070065028 published on Mar. 22, 2007, inventor Byereley claims a system and methods for processing images or data files related to retail transactions. The system includes an image capturing device adapted to capture an image related to the retail transaction; in communication with a transaction file processing device which is in communication with a transaction file storage database. Such a system and methods are intended to update legacy point-of-sale systems with storage databases. This differs from the present invention in that there is no logic associated with decoding and disaggregating customer incentive data to be forwarded to both the existing point-of-sale system and a remote server. Instead patent application 20070065028 is only forwarding data to a data storage facility for future processing.

In published US patent Application 20080208688 published on Aug. 28, 2008, inventors Byerley, Skowronek, and Dewan claim a system and method comprised of enrolling mobile device customers in a discount certificate program. This program builds a participant profile for each customer, from which it creates mobile discount certificates which are communicated to the customers' mobile devices. In such a system, the discount certificates can be pushed to the mobile device or a user might request certain certificates to be delivered. All data exchanges are one-way, wherein the claims fail to address how data is sent back to the same server that issues the discount certificates. Two-way communication with said server is important in order to process customer requests and to determine if coupons were redeemed, ideally in real-time.

In published US patent Application 20090070207 published on Mar. 12, 2009, inventors Engel and Harshawat claim an application of communicating from a remote server to a communication device a plurality of coupons as text data. Once stored in the memory of the communication device, the device is able to replace the coupon text data with locally stored brand indicia to facilitate the user in deciding what coupons to select. Such a system is creative in its way to limit data transfer over costly cellular networks. Though with the present invention, user coupon selection can be conducted through a mobile web browser, allowing the user to eliminate the need to store coupon data on their mobile device all together and even further limit data transfer over cellular networks while having a much larger selection of coupons at hand.

In published US patent Application 20090084840 published on Apr. 2, 2009, inventors Williams and Payne claim a method for conducting transactions at a point-of-sale terminal comprising a hand held device generating an encoded image pattern on its screen, the point-of-sale terminal scanning the encoded image, deciphering the image, and using that information to complete the transaction. As well, Patent Application 20090084840 claims an apparatus for conducting this transaction, comprising: a processor, memory, a screen to display transaction information, and a 2D barcode reader. The methods and apparatus claimed by Patent Application 20090084840 are used to complete a point-of-sale payment transaction. As such, the patent is intended to be used in its preferred embodiment as a payment apparatus for customer checkout. This differs from the present invention in that the present invention does not require scanning of a 2D barcode for payment and the coding of the barcode is completed by a remote server, not the mobile device itself. As well in the present invention, data from the 2D barcode is not only being used by the point-of-sale system as a coupon, but also to be forwarded to a remote server to confirm coupon redemption, track consumer behavior, analysis inventory flow, and more.

In published US patent Application 20040186768 published on Sep. 23, 2004, inventors Wakim and Engestrom claim a system, apparatus and method for a customer to request merchant information and advertising by recognizing the proximity of the customer's communication device or RFID transponder to that of an in-store reader. The request is processed by sending the merchant information to the communications address, using such mediums as SMS, MMS, or voicemail. Such claims require the system to know the location of the customer in order for the customer to access the merchant information. The disadvantage being that if a customer is in need of merchant information but not within proximity of the in-store readers, said customer is unable to access the desired information. Patent Application 20040186768 relies on knowing the location of a user to communicate incentives, whereas the present invention does not.

In published US patent Application 20070088610 published on Apr. 19, 2007, inventor Chen claims methods and systems for redeeming vendor loyalty points and coupons, comprising: providing the consumer with a choice of personal coupons and loyalty redemption options; providing the consumer with a means of selecting at least one of the coupons for redemption; transmitting a barcode representing the coupon selected to the consumer's portable device; and enabling the participating vendor to scan the barcode into a register. With such methods and systems, there is no communication between the vendor's point-of-sale register and the database storing the incentives. As such, it's not possible to confirm in real-time the redemption of incentives, allow for real-time billing to the advertisers, track customer transactions, and more. Additionally, coupon selection is not being conducted over a cellular network using the customer's mobile device; instead the selection is being conducted at the vendor's onsite kiosk. This can be deemed as unnecessary hardware cost as an already existing mobile device is just as capable of selecting electronic coupons.

In published US patent Application 20070150339 published on Jun. 28, 2007, inventors Retter and Bandekar claim systems and a method for creating and retrieving coupons; wherein the coupon database is established and supplied by vendors, registering cell phones with the database; providing registered cell phones with unique decryption codes; supplying encrypted coupon information to a registered cell phone upon request; encrypting the coupon information with the unique encryption code; and decrypting a received requested coupon at the registered cell phone for subsequent presentation and redemption. The intent of the claims is to allow the vendor to provide incentives to a customer on a one time basis, allowing them to do so by registering the customer's cell-phone number against that incentive. Such a system is setup to work between a plurality of customers and one vendor. The more efficient use of database and communication resources, as claimed in the present invention, allows for multiple vendors to use the same database and network for distributing electronic incentives to their customers. Additionally, the disadvantage of patent application 20070150339 is that consumers can not share with each other digital incentives of interest. The present invention encourages a viral network of consumers sharing with other consumers their incentives.

In published US patent Application 20070203791 published on Aug. 30, 2007, inventors Kohl and Madar present a computerized method that monitors activity of the user on a mobile telephone, processes said activity information thereby extracting user data; based on said user data, selects an electronic coupon for the presenting to the user, selecting from a plurality of electronic coupons stored in a database connected to a server application installed on a server connected to the network; and presenting at least one selected electronic coupon to the user. A similar method as just described also applies to an application loaded onto the user's mobile device. Though in either method, such a network does not communicate with the point-of-sale system that the coupon is being presented to, as well does not allow the user of the mobile device to communicate or interact with the server that the computerized method is running on. The disadvantage of such limits the ability to charge advertisers in real-time for redeemed incentives, limits the interest of the mobile device user, and limits the usability of the coupon by the merchant.

In published US patent Application 20060194569 published on Aug. 31, 2006 and 20070087732 published on Apr. 19, 2007, inventor Hsueh claims a process of delivering electronic coupons over a wireless network, comprising the steps of a user registering for an electronic coupon service over a wireless network providing profile information, as such the user enables the wireless network to associate the user with their profile information, and also enabling the wireless network to locate the user within the wireless network; using a portion of the profile information to identify targeted electronic coupons for the user, and transmitting one or more of the targeted electronic coupons by requesting the user to input a code associated with a mobile communication device; and transmitting information associated with the selected electronic coupons to the mobile communication device associated with the inputted code. The wireless network claimed is limited by not being able to communicate with the point-of-sale system that redeems the incentives. This has the disadvantage of limiting the ability to charge advertisers in real-time for redeemed incentives, to track what incentives are being redeemed, and to record user transaction history for future analysis.

In published US patent Application 20060255149 published on Nov. 16, 2006, inventors Retter and Bandekar claim a method for transferring information from a portable electronic device with a display screen to a form readable by a common reflective barcode reader. The inventors are able to so by controlling the pixels of the mobile device's display, mimicking the reflective ‘flickering’ of a barcode reader, for example. All of which demonstrates that technologies exist to read 1D barcodes from the screens of mobile devices. In the case of the present invention, the more robust 2D barcode is preferred for its ability to encode more information than a 1D barcode. 2D/matrix barcodes can be scanned using available digital imaging scanning devices, similar to reflective barcode readers both in shape, size and user operation.

In published US patent Application 20070174116 published on Jul. 26, 2007, inventors Keith, Dunmire, Clark, and Novack claim a method of managing electronic coupons, comprising: receiving an identifier of a purchaser; determining a coupon applicable to an item to be purchased based on the identifier; displaying the applicable coupon to the purchaser via a user device; and identifying the coupon to a point-of-sale terminal. As with many methods and claims that address the distribution and management of coupons, the point-of-sale system that is accepting the incentive is not in communication with the same database and server that is distributing the coupons. As such, this patent application has the disadvantage of limiting the ability to charge advertisers in real-time for redeemed incentives, to track what incentives are being redeemed, and to record user transaction history for future analysis. US Patent Application 20070174116 also claims a similar system, but the user device is only selecting what coupons to redeem from the coupon management database, after which the coupons are sent directly from the coupon management database to the point-of-sale system. In this claim it can be assumed that when the coupon is delivered, it is being redeemed. Such a system is that much slower in its communication speeds as the user device is indirectly communicating with the point-of-sale system through a remote database over a cellular network. This communication speed is indeterminate, certain at times to slow down the checkout process. Additionally, the system claimed by patent application 20070174116 requires substantial modifications to existing point-of-sale systems, which is not always an option with legacy sale terminals.

In published US patent Applications 20080201226 published on Aug. 21, 2008, and 20080167991 published on Jul. 10, 2008, inventors Carlson and Ciurea claim methods for receiving through a payment processing network, an indication of a purchase transaction by a consumer; generating a mobile coupon based upon information from the purchase transaction; and disseminating the mobile coupon to the consumer. This method described here, as well as other methods and system claimed by the inventors for distributing coupons, fails to include any features to allow the user to interact with the processing system that determines what coupons to disseminate to the consumer. As such, the user is not able to select what coupons to present to the vendor. In addition, the user is unable to request coupons, loyalty memberships, or merchant information over their mobile device.

In published US patent Application 20090182634 published on Jul. 16, 2009, inventors Park and Mandke claim a method and system for providing an image-based payment medium comprising the steps of: issuing an image-based payment medium, designating a recipient of said image-based payment medium and a mobile phone number of said recipient; sending an image to said recipient's mobile phone; and scanning said image from said recipient's mobile phone at a point of sale to validate and debit said recipient's said account. Also claimed is that the same system and method can incorporate advertisements in conjunction with the issuing and distribution of the image-based payment mediums. As claimed, the system is strictly one-way communication between the database storing the payment mediums/advertising, and the recipient's mobile device. No network exists for the user to communicate with the distributing database through their mobile device, or for the point-of-sale system to communicate with the distributing database. Thus, the system claimed in patent application 20090182634 is only practical for payment transactions and not incentive distribution and redemption.

In published US patent Application 20090216652 published on Aug. 27, 2009, inventors Eggert and Watson claim a point of sale system comprising: a point of sale register; a processor coupled to said point of sale register, wherein said processor is physically discreet from said point of sale register; and a scanner coupled to said processor, wherein said scanner is configured to scan and capture data such that said processor and said scanner provide additional functionality to said point of sale register. As claimed, the system is not networked with a remote database that manages and distributes incentives for user to display to the point-of-sale scanner. More specifically, the processor that is coupled to the register is only receiving data from the scanner, performing operations on said data and forwarding to the point-of-sale register. Whereas, the point-of-sale system described in the present invention allows for the forwarding of data to a remote backend server for processing and analysis. As well, communication from the backend server to the point-of-sale system needs to be made available for supplementing incentive data and updating of the processor' functionalities.

In published US patent Application 20090307067 published on Dec. 10, 2009, inventor Obermeyer claims a system for presenting to a user of a mobile device coupons for products or services which are available at nearby stores, the system comprising: a network adapted to support communication between the mobile device and a server computer; a mobile device which is adapted to connect to the network; a browser, resident on the mobile device, which is adapted to allow a user of the mobile device to browse a catalog over the network; a coupon database containing a set of coupon offers, wherein each coupon offer is associated with a geographic region. As with many methods and claims that address the distribution and management of coupons, the point-of-sale system that is accepting the incentive is not in communication with the same database and server that is distributing the coupons. As such, this patent application has the disadvantage of limiting the ability to charge advertisers in real-time for redeemed incentives, to track what incentives are being redeemed, and to record user transaction history for future analysis. In addition, the claims rely on knowing the location of the customer, this limits what coupons are made available to the customer.

In published US patent Application 20060180664 published on Aug. 17, 2006, inventors Barrett and Luoma claim systems and methods for delivering supplemental content to an end user on a data communications network and allowing the end user to present the content to a point-of-sale terminal for redemption. The method comprising the steps of: selecting supplemental content for presentation to an electronic display device; transmitting the supplemental content to an electronic display device; receiving acceptance of the supplemental content, downloading at least one time sensitive software application to the end user, activating each unique application at a point-of-sale; redeeming each activated application; and removing the supplemental content associated with the application from the user's electronic display device post redemption. This method and system is at a disadvantage in that it forces mobile device users to download data and applications to their mobile devices and later delete the same data after redemption. This requires allocation of limited memory on the mobile device, the use of costly cellular data transfer and time consuming action of deleting the data after redemption. Additionally, there is no communication from the point-of-sale system to the databases that distributes incentives. As such, there is no means to confirm redemptions; the only confirmation is that the incentive was sent to the mobile device.

In published US patent Application 20080097844 published on Apr. 24, 2008, inventors Hsu and Murray claim a method of handling electronic coupons, the method in its simplified description is an online database containing customer IDs and coupons associated with said IDs. When a customer is interacting with a merchant's point-of-sale system, the system reads the user's ID, likely by having the user swipe their merchant loyalty card. At which point, the POS system reaches out to the online server and queries for any coupons that can be redeemed under said user ID. This method differs from the present invention in many ways, most obviously in that the user's mobile device is not part of the system. As such, the user is not able to interact through their mobile device with the database containing the coupons. US Patent Application 20080097844 is unable to provide many of the novel features associated with a mobile wallet by not having the capability for a user to interact with the coupon server using their mobile device. Additionally, the patent application requires substantial upgrades to the preexisting point-of-sale equipment in order to communicate directly with the distributing database.

In published US patent Application 20080097855 published on Apr. 24, 2008, inventor Rissanen claims a method comprising: wirelessly receiving coupon information; storing data, including the coupon and coupon ID information; displaying a visual representation of the coupon; wirelessly receiving promotions from a terminal granting discounts at a retail outlet; executing software matching coupon information to promotions in a processor; and wirelessly transferring matched coupon information to the terminal and receiving a discount after validation of the transferred coupon. Such a method requires memory allocation on a user's mobile device's already limited memory space. The memory required is partly used for storing coupon information, but also to run a custom software application to process coupons. Additionally, extensive communication is required between the mobile device and the point-of-sale system. The communication between the mobile device and point-of-sale system will slow down the check-out process. For the merchant, a slower check-out process is a more costly process.

In published US patent Application 20080262928 published on Oct. 23, 2008, inventor Michaelis claims a method for distributing and personalizing electronic coupons comprising: transmitting a generic e-coupon identifier; receiving the generic e-coupon identifier along with a request for a redeemable e-coupon; creating a personalized redeemable e-coupon based at least in part on the generic e-coupon identifier; and transmitting the personalized redeemable e-coupon. Such a method as it pertains to distributing e-coupons to a mobile device would require extensive communication between the mobile device and the database hosting the e-coupons. Wherein the mobile device user would need to send a request for the e-coupon and their personal identifier, and wait for the redeemable coupon to be sent back to their mobile device. Patent Application 20080262928 also claims a mobile device wherein the processor is configured with software instructions to perform steps comprising the steps outlined in the method above and storing the received redeemable e-coupon in the mobile device's memory. The user of such a system would be required to install specific application software and allocate memory in the mobile device to allow for e-coupon storage. Additionally, the system and methods allow no means for communicating back to the incentive distributing database the confirmation of a redeemed coupon.

In published US patent Application 20090061884 published on Mar. 5, 2009, inventors Rajan, Moallemi, Koenig, Michaelis, Jacobs, Dos Santos, and Vo claim a method of remote communication, comprising: associating a dynamic mobile coupon (DMC) with a target mobile device, wherein the DMC has at least one variable coupon characteristic; and establishing an initial parameter for the variable coupon characteristic based on a determinable circumstance pertinent to the target mobile device. Dynamic mobile coupons are a novel idea known to practitioners of the mobile ad industry. Such coupons require reliable, on-time networks for communicating the DMC variable of concern. If the DMC is stored on a mobile device and the variable is produced by features associated with the device itself, than limited memory and processing allocations need to be set aside for the DMC, additionally requiring the user to install a custom application. Also inherent to DMCs is the limited, or lack of decision a consumer has in selecting what coupon they desire to redeem.

In published US patent Application 20040267663 published on Dec. 30, 2004, inventors Karns, Beaney, Mathieu, and Kula claim a system for facilitating wireless transactions, comprising: a cellular network; a database of user accounts and transaction types; an electronic infrastructure whereby messages can be sent to mobile devices, said messages displayed on and read from a visual display of said mobile devices, means for receiving information about at least one transaction code and at least one account code as said codes are read from a mobile device display; means for processing said received transaction and account code information; means for attributing said received account code information to an individual user. In such a system, the point-of-sale register that is reading the transaction data off the mobile device is not conducting the financial transaction. It is simply forwarding the data read off the mobile device to the remote database of user accounts and transaction types. After forwarding, the point-of-sale register will have to wait for confirmation of the financial transaction. Such a system relies on the operation and timing of indeterminate networks, such as cellular networks that mobile devices communicate with. In a check-out process, it is of great importance that the financial transaction occurs in a fast and reliable fashion. Additionally, such a system would require substantial upgrades to the point-of-sale system process in order to communicate information to and from the remote database.

In published US patent Application 20090106115 published on Apr. 23, 2009, inventors James and Erdmann claim an electronic coupon redemption processing system, comprising: A. a point-of-sale system configured to recognize and support real-time transactions, the point-of-sale system including: 1) an input device; 2) a processor in communication with the input device; B. a transaction processing system including: 1) a first data structure configured to contain identifiers for a coupons; 2) a second data structure configured to contain selected item identifiers for items that are selected for purchase; 3) a third data structure configured to contain transaction data details; 4) a decision system using the coupon identifiers contained in the first data structure, the selected item identifiers contained in the second data structure, and the transaction data detail contained in the third data structure to process transactions and provide transaction information to the point-of-sale system; and C. at least one data communications network configured to provide communication between the point-of-sale system and the transaction processing system. With this system it is important to note that the processor in communication with the input device is separate from the transaction processing system. The processor in communication with the input device is likely the processor integral to that of the point-of-sale terminal. As described in patent application 20090106115's drawings, the transaction processing system is in direct communication with the e-coupon database, merchant account and multiple point-of-sale terminals. This differs from the interceptor device claimed in the present invention that it is specific to each point-of-sale terminal and forwards coupon redemption codes to said terminals without needing to reference a single, let alone multiple, databases. Put otherwise, the point-of-sale system claimed in patent application 20090106115 requires that it directly communicates with the e-coupon database. As such, preexisting legacy point-of-sale systems will require substantial software modifications.

In published U.S. Pat. No. 7,506,809 published on Mar. 24, 2009, 7086584 published on Aug. 8, 2006, and US Patent Applications 20050222135 published on Oct. 6, 2005, 20070029376 published on Feb. 8, 2007, 20090145958 published on Jun. 11, 2009, inventors Stoutenburg, Mollett, Price, Fillinger, Nelson, Seifert, and Singleton claim methods and systems for effectuating a value transfer from one or more point-of-sale devices. To simplify and summarize, Stoutenburg claims associating a plurality of point-of-sale devices with a point-of-sale control system, where one of the point-of-sale devices is associated with a loyalty card system and a remote transaction system. In addition, one of the point-of-sale devices can be remotely configured by the remote control system. The result is a complex network of devices and control systems that allow for instruction-based remote reconfiguring, updating of the entire point-of-sale system, as well implementation of a loyalty incentive program. The present invention claims a system for adding functionality to a point-of-sale system, but does so much differently. The present invention introduces hardware that does not replace any existing point-of-sale devices. Additionally, the hardware introduced does not require communication across point-of-sale terminals for recognizing loyalty users or for updating firmware.

In published US patent Application 20080228567 published on Sep. 18, 2008, inventors Williams, Bykov, and Belvin claim a computer implemented system comprising an online storage component that stores coupon data for a consumer, a point of sale terminal that receives a payment from a customer and obtains the coupon from the online storage component. The system claimed requires that the point-of-sale system be in communication with the distributing coupon database. As such, most legacy point-of-sale systems will require substantial hardware and software upgrades to accommodate the claims presented in patent application 20080228567. In addition, waiting on communications over an indeterminate network is highly susceptible to long wait times, resulting in a slower checkout process for the customer and merchant.

In U.S. Pat. No. 7,318,551 published on Jan. 15, 2008, and patent application 20080105743 published on May 8, 2008, inventor Mill claims a device including: a keyboard connector to communicate with a keyboard; a system connector to communicate with a system unit; a wireless interface to communicate with a wireless peripheral; a switch having inputs coupled to the keyboard connector; the switch having an output coupled to the system connector; wherein the switch couples the serial interface to the system connector when there is data activity from the wireless peripheral and couples the keyboard connector to the system connector when there is no data activity from the wireless peripheral. This adapter is a standalone device and not integral to a system. The device performs a switching function, essentially merging two input data sources into one. The interceptor device described in the present invention is able to perform operations on incoming data (regardless of the device the data originated at) and optionally sends the data off to one or more devices. The interceptor's logic and multiple communication means makes it an integral part of the system claimed in the present invention.

In published US patent application 20040122738 published on Jun. 24, 2004, US patent application 20080177899 published on Jul. 24, 2008, US patent application 20080022017 published on Jan. 24, 2008, U.S. Pat. No. 6,272,529 published on Aug. 7, 2001, and U.S. Pat. No. 7,203,728 published on Apr. 10, 2007, inventor Luz claims a distributed computer network for use with a general purpose computer having a communications port and capable of running applications software for controlling the network. The distributed computer network includes a master controller having first and second communications ports, the first communications port of the master controller for operatively communicating with a general purpose computer. The second communications port for serially communicating with one or more peripheral devices. The peripheral devices are connected together in a serial daisy chain configuration. The master controller communicates with the input/output controllers. The master controller also communicates with the general purpose computer so that the master controller performs protocol management functions including conversion between RS-232, USB, Ethernet, or wireless interfaces and RS-485 or Ethernet protocols, error correction and detection, bus arbitration and data buffering. In comparing Luz's prior art to the present invention, it's important to note that the network claimed by Lutz is not intended to operate remotely (i.e. outside of brick and mortar walls). Additionally, the network is managed by the master controller, not the general purpose computer; whereas the present invention is managed remotely by a central server.

In published US patent application 20070244991 published on Oct. 18, 2007, and U.S. Pat. No. 7,424,512 published on Sep. 9, 2008, inventor Dowling claims a method that comprises a smart phone that is preferably equipped with a wireless local area network (LAN) connection and a wireless wide area network (WAN) connection. The LAN network connection is used to establish a position-dependent ecommerce network connection with a wireless product or service access device supplied by a vendor. A negotiation sequence is carried out to electronically contract the services of the negotiated wireless peripheral from the vendor using a prepaid ecommerce protocol. The negotiated wireless peripheral is a general product or service vending device and the smart phone acts as a digital authentication and payment device with digital pre-paid payment capabilities. This technique is useful for ticketing and admission systems to events. Here the smart phone is using its cellular connection and its LAN connection to conduct commerce or authentication. One might be inclined to compare the smart phone to that of the communicator device described in the present invention given that both communicate using two different wireless communication protocols. The communicator differs in that it is a device that is integral to a larger system, is not operated by a consumer, and is capable of communicating with one or more peripheral device simultaneously. Additionally, the application running on the smart phone claimed by Dowling is required to be compatible with the applications run by the vendor. Whereas the present invention does not require a mobile device user or a vendor operating a POS system to load new software.

In published U.S. Pat. No. 7,483,679 published on Jan. 27, 2009, inventor Kurobe claims a portable-terminal holder comprising a first radio communication device comprising: a base having a portion on which said portable terminal is placed, and a charging device for charging said rechargeable battery; and a communication module having a second radio communication device communicating with said first radio communication device for wireless data transmission between said portable terminal and said communication module, and a cable communication device communicating with an external host computer for cable data transmission between said host computer and said communication module, said communication module being configured to be detachable from said base. U.S. Pat. No. 7,483,679 claims two radio communication devices that are attached to a portable terminal and are only communicating with each other and a host computer over a cable connection. The present invention is similar in that the system is composed of communication devices, though differs in numerous ways. First, the present invention's communication devices are able to perform operations on passing data and are capable of logically directing data traffic to other peripheral devices, unlike U.S. Pat. No. 7,483,679. Additionally, the present invention's system is comprised of a remote server, not an onsite host computer. The remote server has the crucial benefit of communicating with numerous sites in real-time. Additionally, the relay/communication device claimed by U.S. Pat. No. 7,483,679 is not capable of intercepting data, duplicating data, and forwarding data to two different ports. Lastly, it's important to note that in the present invention, each barcode scanner is assigned to one interceptor device and one existing POS terminal. As opposed to U.S. Pat. No. 7,483,679, where each barcode scanner is assigned to one of, but not both, a host computer or a POS terminal.

In published US patent application 20050198393 and 20030028563 published on Sep. 8, 2005 and Feb. 6, 2003 respectively, and U.S. Pat. No. 6,886,046 published on Apr. 26, 2005, inventor Stutz claims the method and apparatus for the aggregation and display of information on a device, the apparatus comprising: a communications module delivering information to and receiving information from the device; an assimilation agent receiving information from at least one information source; and an integration server in communication with said communications module and said assimilation agent, said integration server receiving said encapsulated information from said assimilation agent, said integration server comprising a rules engine for processing said encapsulated information in accord with a predefined set of rules, and said integration server providing said encapsulated result to said communications module. The claims made by Stutz differ from the present invention in that Stutz's methods are supporting the transfer of information to be displayed on a client device. Additionally, the methods are not designed around an existing data utility infrastructure as the present invention is. The present invention is spliced into existing data flow for capture and delivery. Stutz's novel ideas are not designed for, or able to intercept already existing data flow.

In published US patent application 20090265445 published on Oct. 22, 2009, inventor Lewis claims a discount administration apparatus comprising: a WAN interface; a mobile communication network interface; a database linking a user id to one or more product ids; and processing means, wherein the processing means is configured for sending said user id to a communication user agent via the mobile communication network interface and for responding to a request message. The apparatus claimed, a mobile phone, in patent application 20090265445 differs from the present invention in that it requires legacy POS systems to be upgraded with new hardware and software to be able to communicate with a mobile phone utilizing a WAN connection. Additionally, there is no method for a mobile phone user to view redeemable coupons prior to checkout. The only data stored on the user's mobile device is their user ID. As such, there is no inducement for the customer, the mobile phone user, to purchase a product associated with a coupon. Essentially US patent application 20090265445 is an apparatus only intended to deliver coupons.

In published US patent application 20040025047 published on Jun. 6, 2003, inventor Mayne claims a wireless communications network comprising: a plurality of network nodes which can communicate wirelessly with a plurality of end stations coupled to the network; and a network server, wherein the network nodes are connected to the network server and the network server is connectable to other communications networks, the network nodes and network server including: identification means to store and access details relating to the end stations; memory means to store data which is to be communicated to a user in one of a plurality of different protocols; and transfer means to connect different data streams. The networked claimed in US patent application 20040025047 is intended to communicate data to retail devices. The network is installed separate from any existing systems, as compared to the present invention's network which is integrated into existing, legacy systems. The prior art does not claim any sort of intercepting device to operate on, duplicate, and deliver existing data flows.

In published U.S. Pat. Nos. 6,549,625 and 7,149,541 published on Apr. 15, 2003 and Dec. 12, 2006 respectively, inventor Rautila claims a communication system, comprising: an information source, a position transceiver disposed at a broadcast location and coupled to the information source, the position transceiver broadcasting information from the information source within a broadcast area, the broadcasted information including identification information relating to the information source; and a mobile terminal within the broadcast area comprising first and second transceivers, the first transceiver communicating with the position transceiver and the second transceiver communicating with a network; wherein the identification information comprises a pointer which identifies a location of the position transceiver associated with corresponding data of the information source. U.S. Pat. Nos. 6,549,625 and 7,149,541 claim a wireless network communicating with a mobile terminal; the mobile terminal concurrently communicating with a separate network. The claimed network only conducts communication in one direction, to the mobile terminal. There is no collection of data at the mobile terminal, there is no intercepting device to operate on, duplicate, and deliver existing data flows. The information being broadcasted, as explained in the prior art, is for supplementing the mobile terminal, not for collecting data being delivered to the mobile terminal.

In published U.S. Pat. No. 6,452,910 published on Sep. 17, 2002, inventor Vij claims a two-way wireless communication system comprising: a plurality of wireless personal area network devices; a wireless local area network device; and a wireless bridge apparatus having a first transceiver module for two-way data communication with said personal area network devices and having a second transceiver module for two-way data communication with said local area network device; wherein: said wireless bridge apparatus provides a first coverage area for communication with said personal area network devices and a second coverage area for communication with said local area network device; and said first area being smaller than said second area and being entirely contained within said second area. This apparatus differs from the communicator apparatus in the present invention in that it does not communicate with a server off the LAN (i.e. a remote server). A remote server is vital to the present invention in that it allows data collection at multiple locations to be viewed and processed at one location. A remote server would have to be reached using an internet or cellular connection, both of which are not claimed by Vij.

In published U.S. Pat. No. 7,095,748 published on Aug. 22, 2006, inventor Vij claims a communication system for providing a communications link between a moveable wireless device and a remotely located internet connected backend server, the moveable device having no internet protocol address; the system comprising: at least two communication multiplexing devices positioned at spaced apart locations and forming separate coverage zones for two-way communication with said moveable device when said moveable device is located in a corresponding zone; each said multiplexing device having a unique internet protocol address and a separate connection to said server; and automatic buffering and switching means for selecting an alternative internet protocol address and separate connection between the server and a corresponding multiplexing. U.S. Pat. No. 7,095,748 differs from the present invention in that the present invention is spliced into existing data flow for data capture and delivery. The communication network presented by Vij is not designed to (or able to) intercept and operate on an already existing data flow.

In published U.S. Pat. No. 6,091,956 published on Jul. 18, 2000, inventor Hollenberg claims a situation information system comprising: (A) mobile computers with radios transmitting information including location data, receiving situation information, and continually receiving telephone numbers while conducting shopping functions in shopping areas including stores and malls; (B) Radio locating means by which, the location of each of said mobile computers is determined and processed into location information; and (C) One or more radio sources of said situation information, for purposes including presenting entertainment, commercial offers, and advertising. U.S. Pat. No. 6,091,956 is one of many examples of a mobile computer designed for use by customers in a retail setting. The present invention does not claim a mobile computer device; rather it is concerned with capturing retail data from one or more retail locations and transmitting that data to a central remote server for processing.

In published US patent application 20070239569 published on Feb. 7, 2006 and Oct. 11, 2007 respectively, inventor Lucas claims a system for managing assets of an enterprise, comprising: (A) A plurality of managed asset units, each tagged with a unique identifier; (B) A first asset reader, having an associated first location; (C) A first interface for entering or reading identity information of a user at the first location; (D) A second asset reader, having an associated second location; (E) A second interface for entering or reading identity information of a user at the second location; (F) At least one data server, configured for determining the location information for an asset unit based on the coverage areas of the asset readers; and (G) A client device which is connected to the data server, and includes a display device configured to display a plurality of user-selectable data queries corresponding to stored assets. US patent application 20070239569 claims an asset tracking system comprising multiple readers, a data server and a client device used to interact with the data. The patent does not claim how the network will be assembled, specifically how the data communicated from the data collection devices to the server. This becomes that much more evident when multiple systems are setup in different sites and all systems need to communicate with a single remote server. The present invention addresses this issue where as US patent application 20070239569 does not.

In published U.S. Pat. No. 6,757,689 published on Jun. 29, 2004, inventor Battas claims a method for running an enterprise as a zero latency enterprise (ZLE), the enterprise experiencing a plurality of events occurring in association with business transactions conducted at a plurality of sites across the enterprise, the method comprising: Integrating, in real time, enterprise-wide data, applications, business transactions, operations and values, by capturing, in real time, an indicia of each of the plurality of events, each indicia being associated with information related to its respective event, aggregating, in real-time, the information related to the plurality of events in a central repository where the aggregated information can, in real-time, be accessible and available for extraction and analysis from across the enterprise, so as to provide a coherent view, in real time, of the aggregated information from across the enterprise and so that the enterprise can achieve enterprise-wide coherent and zero latency business transactions, and initiating, in real time, a process responsive to each event of the plurality of events which is founded on the coherent view of the aggregated information. Here Battas claims that all transactions occurring within an enterprise deliver or extract information from a single, central repository. In the situation where the enterprise spans across multiple locations, the central repository must become remote, communicating over a network with indeterminate timing (i.e. the internet). The present invention does not require retail transactions, of any type, to reference the remote server in order for the POS system to process that transaction. This is a crucial attribute of the present invention that allows it to succeed.

In published US patent 20040128197 published on Jul. 1, 2004, inventor Bam claims a system for distributing and redeeming a promotion, said system comprising: a processor for generating promotion data; an electronic device operable for receiving generated promotion data; and a database accessible by said processor, said database operable in conjunction with said processor for storing information used for generating said promotion. US patent application 20040128197 differs from the present invention in that in US patent application 20040128197 the redemption of a promotion is handled by a user's mobile device communicating to a server. The prior art provides no means for communication between the POS system and the central server. As such, the user of the mobile device is required to alert the central server to what incentives were redeemed and where. It is possible that the POS system could communicate bi-directionally with the mobile device and share this information in automated fashion. But such a novelty requires legacy POS systems to be updated with new hardware and software. This is not a feasible option if the promotion technology is to succeed.

In published US patent application 20070185756 published on Aug. 9, 2007, inventor Ahn claims a shopping pattern analyzing system comprising: a tag attached to a shopping cart, a plurality of readers for reading information of the tag through local area radio communication and transmitting the read information through a network; an analysis module for analyzing the shopping pattern, a database in which the information of the tag and analysis data are stored; a system server for managing the analysis by performing communication with the readers, and controlling the analysis module and the database. US patent application 20070185756 simply refers to a network for integrating all the components of the shopping pattern analyzing system within a single retail location. Whereas many of the novel ideas of the present invention reside in providing an easy, quick, and economical solution to integrate data reading devices, at multiple locations, with a remote server.

In published US patent application 20040062213 published on Apr. 1, 2004, inventor Koss claims a mobile information system comprising: a mobile client running a mobile hyperlink browser to communicate with one or more remote servers, wherein geographically-dependent hyperlinked content is available from the servers; wherein the mobile hyperlink browser sends resource requests to the servers; and wherein a resource request from the mobile hyperlink browser includes geographical coordinates indicating a current location of the mobile hyperlink browser. The idea of providing location based incentives has been around much longer than the claims made in US patent application 20040062213. What Koss is claiming is a unique way of two way communication between the client device and the server utilizing a mobile hyperlink browser. The present invention uses location data to help generate location based promotions. Wherein the present invention's novel ideas are concerned with delivering and redeeming these promotions by utilizing in store data communication devices. Put differently, US patent application 20040062213 only makes available location based information, whereas the present invention utilizes location based information.

In published U.S. Pat. No. 6,680,923 published on Jan. 20, 2004, inventor Leon claims a communication system for wireless data communication said system comprising: a wireless communication device, including a unique identifier, conducting data communication through an over-the-air network, a computer configured for network access, a transceiver assembly operative on a short range communication standard and structured to interconnect said wireless communication device with a computer facility to establish data communication therewith, said transceiver assembly including a first transceiver connected to said computer and at least a second transceiver connected to said wireless communication device and an auto-switching capability responsive to pre-determined parameters, said auto-switching capability being determinative of data communication with said wireless communication device, and at least one of said predetermined parameters comprising a pre-established vicinity range. U.S. Pat. No. 6,680,923 is allowing mobile devices (i.e. cell phones) to easily transfer between cellular and WLAN communication means. The present invention is composed of wireless communication devices, though since these devices are stationary there is no need to dynamically switch between communication means based on pre-determined parameters.

In published US patent application 20040030601 published on Feb. 12, 2004, inventor Pond claims a system for facilitating electronic payments in a food service setting using a mobile device enabled for short range proximity signaling and two way messaging, said system comprising: a proximity reader for interacting with said mobile device; a plurality of servers for providing authentication of user and processing payments; a plurality of point of sale terminals to provide access to transaction information; and a messaging system for providing mobile commerce messaging with said user, wherein said mobile commerce messaging includes digital content of at least one of digital cash, coupons, etc. . . . US patent application 20040030601 differs from the present invention in that the system as claimed cannot be easily and economically integrated into an existing payment processing system. The claimed system would require replacement of hardware and/or software. The present invention allows for all payment processing systems (hardware and software) to remain, but still adds the ability to capture, in a central location, purchase transaction information in real-time.

In published US patent application 20010023407 published on Sep. 20, 2001, inventor Liyanearachchi claims a method of communicating data for distributing incentives to consumers over a communication network to enable redemption of incentives and for generating invoicing data for suppliers of the redeemed offer or incentive, comprising the steps of: a) storing data representing the conditions of the incentives in a first database associated with communication network site, b) providing data from the first database to a consumer in response to a consumer request made directly or indirectly to the first database from a consumer communication node connected to the communication network, c) providing a transactional second database for recording data transactions on the first database, d) receiving data representing selections made by the consumer from the offers and/or incentives and transmitting the selections data over the communications network to a retailer's network site, e) further updating the transaction database in respect of any selections for which purchases were not fulfilled by the retailer, and f) generating invoicing data from the transaction database for invoicing manufacturers and/or suppliers for offers redeemed by retailers. US patent application 20010023407 claims a method for the delivery and redemption of promotional incentives and other information to online shoppers from a co-operative communication network site. The present invention overcomes the problems associated with presenting and redeeming mobile electronic incentives within brick and mortar locations, not internet e-commerce.

In published US patent application 20090089148 published on Apr. 2, 2009, inventor Gujjar claims a system for delivering promotions to a consumer, the system comprising: data acquisition circuitry communicatively coupled to a POS communication channel and configured to acquire consumer identification or transaction data traversing via a POS terminal; and a processor configured to generate one or more promotions to be offered to the consumer based on the acquired data. The system that Gujjar claims is only for delivering promotions to the consumer at a POS terminal, not coupon redemption. Whereas the present invention's novel ideas lie in the coupling of a promotion delivery and redemption system. For example, in US patent application 20090089148 the customer that is receiving the coupon has to wait at the POS terminal until the coupon is generated. This slows down the checkout process, especially if the processor and database are located remotely and communicating over an indeterminate network timing (i.e. the Internet). Whereas in the present invention, the customer does not have to wait on the POS terminal to receive their coupon. Instead, the coupon is uploaded to their mobile wallet shortly after the customer departs the POS terminal. It's possible that that Gujjar's invention could have the processor communicatively coupled through a local area network, where network timing is determinate. But then the system is at the major economical disadvantage of having to keep large databases onsite at each retail location. Additionally, by coupling the coupon redemption and delivery system, the present invention is that much more efficient at matching the right coupon to the right customer. In that the system can collect and compare a customer's coupon delivery, redemption, and purchasing history when generating new incentives.

In published US patent application 20090299788 published on Dec. 3, 2009, inventor Huber claims a method for providing location-based services by utilizing an enterprise femtocell network. Femtocells differ from the devices claimed in the present invention in that femtocells are essentially signal boosters for cellular devices. They can have the added functionality of coupling to cell data, data that is unique to that femtocell. However, femtocells require that peripheral devices communicate with the femtocell using one specific type of cellular technology (e.g. GSM, CDMA, etc). If a retailer wants to support all customers and their mobile devices, a retailer will be forced into purchasing and installing multiple costly femtocells, each cell dedicated to a specific data carrier and cellular technology.

In published U.S. Pat. No. 7,119,759, published on Sep. 17, 2002 and US patent Applications 20060279527 and 20050122564, inventor Zehner et. al. presents an invention that provides a reflective electro-optic display having a bar code display area arranged to display a bar code readable by a bar code scanner. Zehner recognizes the novelty of a display that is both readable by humans and a barcode scanner. The invention however does not address the need to read a 2D barcode image, disaggregate the coded image, and convert the image into a machine readable 1D barcode. As such, the invention does not present or imply any sort of means to convert 2D coded images into 1D machine readable barcodes.

In published US Patent Applications, 20110029363 and 20100250351, published on Mar. 19, 2010 and Sep. 30, 2010 respectively, inventors Gillenson et. al. claim a computer implemented incentive transaction system. The invention calls for no changes to legacy point-of-sale systems to communicate a consumer incentive for redemption. Instead, the invention relies on a customer's cellular network to communicate the redemption of incentives. All of which occurs during the checkout, forcing the check-out process to pause while redemptive action requirements are communicated over a network for an indeterminate amount of time. As a result, the time it takes to complete the checkout process increases for an indeterminate amount of time.

In published US patent Application 20110017818, published on Mar. 19, 2010, inventor McGill, Randy D. presents a novel device for communicating coupon data to a point-of-sale system via a blinking light emitting diode that is in communication with a mobile phone device. Note that the invention does not present any means for communicating coupon data to a point-of-sale system via the mobile device's human readable screen. Instead the invention relies on the mobile device having an LED and associated software, or relies on connecting a stand-alone module to the mobile device that contains the blinking LED. Many mobile devices will require the latter, a cost prohibitive option for communicating digital incentives.

In published US patent Application 20100312633, published on Jun. 8, 2009, inventor Cervenka, Karen L. claims a payment processing network between consumers and merchants that makes use of transferring data between the consumer's mobile phone device and the merchant's point-of-sale system. The patent makes no mention of aggregating multiple coupons into one coded image, nor does the patent address the present day difficulties of scanning a 1D barcode image from a human readable display device. Lastly, the invention presents no way for the point-of-sale system to communicate, in real-time, to the coupon provider server that the data has been read from the screen of the mobile device, in other words that the coupon has been redeemed.

In published US patent Application 20100125497, published on Feb. 18, 2009, inventor Arguello, Dale Junior claims a coupon redemption system, wherein an electronic device displays a barcode image corresponding to coupon information, wherein the barcode image is adjustable in response to an indication of the type of electronic device. This barcode image would then be scanned by a point-of-sale system. The patent does not present any means to aggregate multiple coupons into one barcode image, nor any communication means for the point-of-sale system to communicate, in real-time, to the coupon provider server that the data has been read from the screen of the mobile device.

Much of the prior art that is related to adding functionality to merchant sales or related to facilitating data collection does not recognize the importance of real-time data analysis, consumer interest and interaction, avoiding reliance on indeterminate network timing, low costs and easy to integrate solutions, central data collection, and more. Thus, there remains a need for improved systems, methods, and devices for adding functionality to merchant sales and facilitating data collection.

### SUMMARY OF THE INVENTION

The present invention is comprised of systems, methods, and devices for adding functionality to merchant sales and facilitating data collection. The system and its methods are comprised of on-site devices for processing and communicating data to an off-site remote server. The remote server is utilized for hosting databases and interactive applications.

The present invention, in its various embodiments, function under a multitude of uses. One such embodiment allows advertisers to offer customized, easy to redeem electronic incentives and makes available to customers an electronic mobile wallet. Further embodiments exist to add functionality to legacy point-of-sale systems (or any other data utility system), to provide a central data collection means, or to exist as an independent data collection system. All of which can be accomplished at a low cost, with easy to integrate devices, none of which requiring hardware or software updates to pre-existing systems. The integrated network functions on a real-time basis, providing instant updates, billing, inquiries, sales processing, incentive processing, and more, while benefiting one or more of the following: manufacture, retailer, and customer.

One such embodiment exists with the means to redeem and distribute electronic incentives. The embodiment is designed to efficiently deliver, manage, and redeem electronic incentives to a plurality of customers and to a plurality of merchants serving said customers. Wherein the retailer is typically motivated to gain shopper insight, to build consumer affinity, to increase consumer consumption, and to increase the number of consumer trips to the retailer's stores.

Electronic incentives, such as electronic coupons, loyalty member services, electronic advertising, gift cards, and more, have been in use during the past few years but have yet to become ubiquitous. The novel ideas behind the present invention address and solve the common problems associated with electronic incentive; issues that have prevented the mobile ad industry and its technology from expanding. These issues are listed below:

limiting data storage and processing demands on a user's mobile device, or

limiting data transfer over costly cellular networks, or

eliminating consumables (e.g. paper), or

limiting customer's need to handle, track and organize incentives, or

communicating between the point-of-sale terminals processing the electronic incentives and the remote server that distributes the incentives, or

limiting the time it takes to complete the check out process, or

creating coupon redemption codes dynamically that support the inclusion of customer specific information, or

easily allowing devices to scan the display of a mobile device, or

allowing user's of electronic incentives to interact with the distributing server, or

eliminating the need to develop software applications specific to a mobile device's architecture and operating system, or

allowing the option to bill advertisers only for incentives redeemed, or

ensuring easy to implement systems to integrate with legacy point-of-sale systems, or

ensuring redemption of only valid incentives

The incentive redemption embodiment, outlined in one embodiment, addresses the above issues with a system comprised of a user's mobile device with a screen display and internet browsing capabilities. The user's mobile device is in communication with a point-of-sale scanner or imaging device by displaying on its screen a single barcode image coded to store one or more coupons, member loyalty ID, encrypted user ID, and like information. A processing communications device, also known as the interceptor device, is placed in series with the output of the point-of-sale scanner and the input of the point-of sale register. The interceptor device is intended to disaggregate and operate on pertinent data delivered from the scanner, duplicate, and selectively forward/disseminate this data to the point-of-sale system and the on-site communicator device. The communicator device is communicating wirelessly with the interceptor device and a remote server. The remote server can be accessed by a plurality of trusted parties, including mobile device users.

In a further embodiment, interceptor device is integrated into the same enclosure as the imaging device and communicator device. The integrated interceptor device still addresses all the shortcoming of existing electronic incentive distribution systems, but now has the added feature of providing an e-coupon processing system with only a single device needed at a point-of-sale station. Additionally, the integrated interceptor device can be outfitted with a barcode readable display such that legacy point-of-sale barcode readers can be used to read in data processed by the integrated interceptor. While at the same time, the integrated interceptor remains untethered from the point-of-sale station, requiring no communication protocols to be in place between the systems.

Many of the same components used to distribute and redeem electronic incentives are used in further embodiments as a data management system to track inventory, add visibility to store sales, better understand customer behavior, collect data in a central location, or any other use of a data utility system.

The data management system is designed to easily integrate into current legacy data utilization systems (e.g. point-of-sale register), or to be setup independently. The result is real-time viewing and analysis of data from multiple locations. As many business tools become data centric, there is a growing need to collect data in a centralized location for viewing and analysis. Current solutions to meet this need fall short in a number of areas, some of which being:

avoiding replacement or modifications to existing data management hardware or software; or

allowing to continue to forward data to pre-existing data utility systems; or

providing a central location for the collection and analysis of data; or

selectively deciding what data to forward to data collection.

In one embodiment, the present invention addresses the above issues by placing an interceptor device in series with an existing data reading device (such as barcode scanner, RFID reader, image reader, and various sensors) and an existing data utility system. The interceptor device is designed to operate on pertinent data delivered from the data reading device and to disaggregate, duplicate and selectively forward/disseminate this data to the on-site communicator device and/or a pre-existing data utilization system. The communicator device is communicating wirelessly with said interceptor device and a remote central server. It is at the remote server that data is viewed and analyzed by all interested and trusted parties.

### DRAWINGS

FIG. 1 is a block diagram of the interceptor device hardware according to one embodiment of the present invention

FIG. 2 is a block diagram of the communicator device hardware according to one embodiment of the present invention

FIG. 3 is a three-dimensional drawing of the communicator device according to one embodiment of the present invention

FIG. 4 is a block diagram of a further embodiment of the interceptor device, referred to as the integrated interceptor device

FIG. 5 is a three-dimension drawing of the integrated interceptor device

FIG. 6 is a three-dimensional drawing of one embodiment of an accessory device that attaches to the integrated interceptor device.

FIG. 7 is a block diagram of the remote server according to one embodiment of the present invention

FIG. 8 is a screen shot of one embodiment of the homepage of the electronic mobile wallet application

FIG. 9 is a screen shot of one embodiment of a selected mobile coupon display

FIG. 10 is a screen shot of one embodiment of the coupon inventory webpage

FIG. 11 is a block diagram of the off-site system according to one embodiment of the present invention

FIG. 12 is a block diagram of one embodiment of the electronic incentive distribution and management system inside the walls of a merchant store

FIG. 13 is a block diagram of a further embodiment of the electronic incentive distribution and management system inside the walls of a merchant store

FIG. 14 is a block diagram of a further embodiment of the electronic incentive distribution and management system inside the walls of a merchant store

FIG. 15 is a block diagram of the on-site data collection system according to one embodiment of the present invention

FIG. 16 is a block diagram of the on-site merchant data collection system according to one embodiment of the present invention

FIG. 17 is a flowchart of the electronic incentive distribution and management method according to one embodiment of the present invention

FIG. 18 is a flowchart of the electronic incentive distribution and management method, including the integrated interceptor device, according to one embodiment of the present invention

FIG. 19 is a flowchart of the electronic incentive distribution and management method, including the integrated interceptor device, according to one embodiment of the present invention

FIG. 20 is a flowchart of the electronic incentive distribution and management method, including the integrated interceptor device, according to one embodiment of the present invention

FIG. 21 is a flowchart of the data processing method, including the integrated interceptor device, according to one embodiment of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted in order to more clearly illustrate the invention.

Throughout this document various systems, devices, means, and components are said to be in communication with other systems and components. Without limitation, in communication means the exchanging of information, bi-directionally or uni-directionally, between at least two devices or two means. In most cases, it is described as to how this data is being communicated. This is different from referring to the sending and forwarding of data. Without limitation, sending and forwarding of data is uni-directional data exchange between at least two devices or two means. Lastly, if a device or means is exchanging data with multiple devices or means, it is assumed that data exchanges can occur simultaneous between the multiples devices or means.

Throughout this document various systems, devices, means, and components are described as being ‘on-site’ or ‘off-site’. Without limitation, on-site and off-site are synonymous with location A and location B. Wherein the two locations are typically out of sight of each other, separated by physical walls, large distances, etc. . . . Additionally, without limitation, off-site is synonymous with remote.

Throughout this document, the terms barcode and coded image are used, without limitation, to describe 1D traditional barcodes and a 2D/matrix barcodes interchangeably. When ‘1D barcode’ and ‘2D/matrix barcode’ are used, the terms are referring specifically to that type of barcode. A barcode is a data image coded in a format that is recognizable and readable by a barcode imager or barcode scanner.

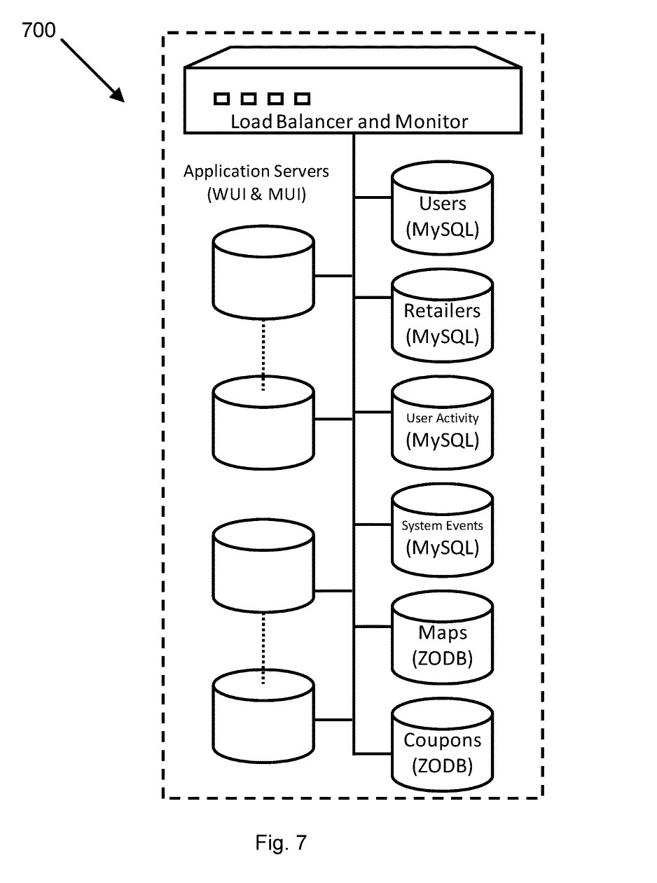

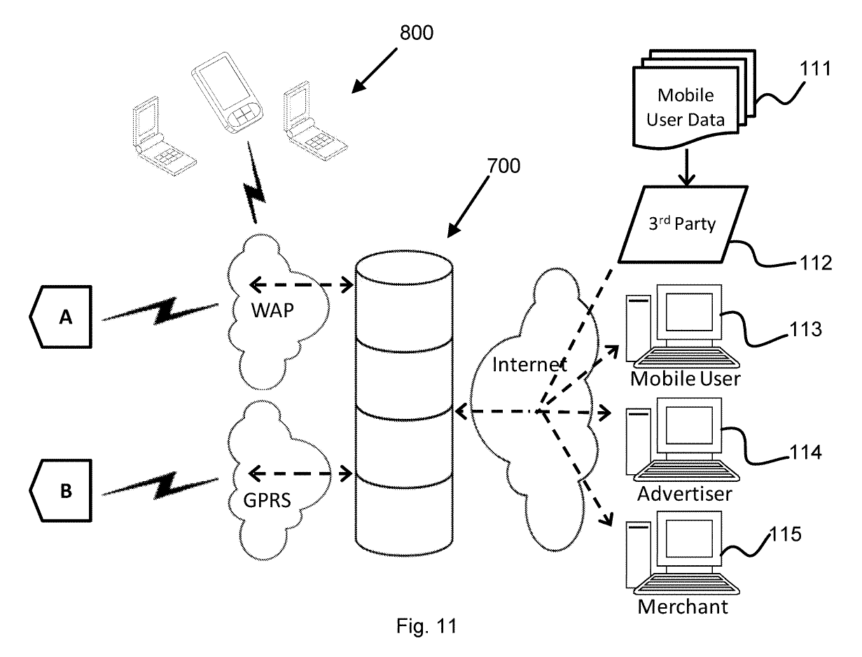

FIG. 11 depicts one embodiment of the present invention's top-level system to facilitate merchant sales, inventory management, incentive distribution/redemption, ticket processing, or data collection. Central to which is the means for hosting databases and applications, such as Remote Server 700, which in one embodiment is comprised of multiple databases (as depicted in FIG. 7), monitored and controlled by a trusted identity. Remote Server 700 is utilized for many purposes, most notably for hosting content and interactive applications that allows a plurality of trusted individuals, including users of Mobile Devices 800 to access Remote Server 700 through standard Internet browsing software. The utilization of storing data and applications remotely is commonly referred to as ‘cloud computing’.

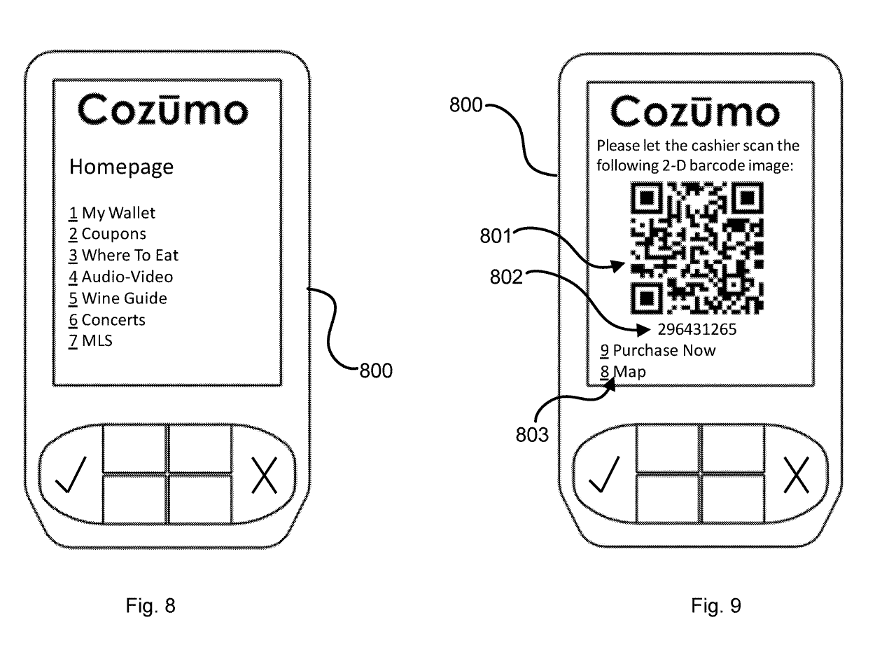

Mobile Device 800 can communicate and access Remote Server 700 through the device's cellular network using common software that is a part of the Mobile Device's 800 operating system. The preferred embodiment of the present invention utilizes a WAP (wireless application protocol) browser to communicate and access content and interact with the applications hosted on Remote Server 700. Further embodiments of mobile devices may include other protocols such as HTML, and non-WAP protocols such as downloadable applications that run on the mobile device's operating system. Once connected, mobile users are presented with an interface similar to that presented in FIG. 8. In this figure the user of Mobile Device 800 is viewing their homepage with the option of accessing their mobile wallet, coupons of interest, video/audio content, venue tickets, guides or attractions within their near proximity. The interface is designed such that hyperlinks can be easily selected by pressing a single key on the Mobile Device's 800 numeric or alpha numeric pad. As well, the user can scroll up/down or left/right if need be to view additional content that is not able to fit on the viewing screen.

A user's electronic wallet application, or mobile wallet, is an analogy to that of the conventional wallet. In the present invention, one of the main features provided by the mobile wallet is access to coupons of interest as depicted in FIG. 9. When presented with a coupon, the user has the option of accessing an interactive map that depicts the location of the coupon. This is accomplished by the user simply selecting hyperlink 803, at which point a WAP enabled browser presents an interactive map to the user. In the present invention's preferred embodiment, depicted on the map are the locations that said coupon can be redeemed within Mobile Device 800 user's near vicinity. Coupons stored in the mobile wallet were selected and stored by the user or by an automated algorithm. As well, the mobile wallet allows a user to access their loyalty membership IDs, electronic payments, transaction history (receipts), gift cards, tickets, profile information and more. Again, this interacting between the user and their remote mobile wallet is all completed by communicating and interacting with applications hosted on Remote Server 700.

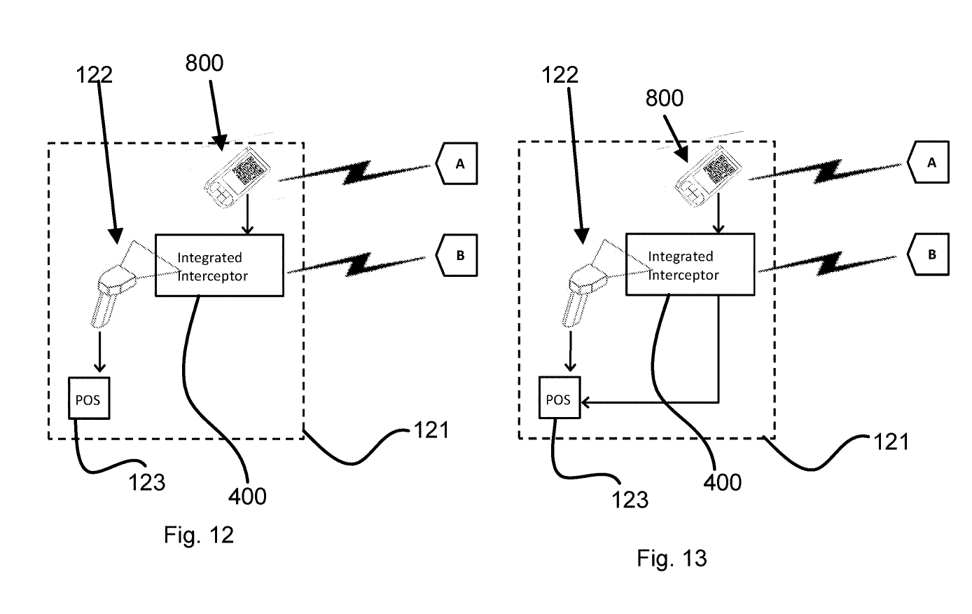

At checkout, the mobile device user will approach a merchant's POS Terminal 123, or any other type of data utility system, with Mobile Device 800 at hand as depicted in FIG. 12-14. Previous to approaching POS Terminal 123, the user will select what incentives to present to the terminal. Selection can be completed by selecting one coupon at a time, or by a semi-automated means where the user might select the merchant's name on their mobile wallet and all incentives relating to that merchant are automatically selected. At which point, software running on the remote application hosting the mobile wallet will aggregate all coupons, loyalty member IDs, gift cards, user ID, or any other form of digital information (“incentives”) into one barcode or coded image, such as Barcode 801 as depicted in FIG. 9. Also included in the data is the mobile wallet owner's encrypted or unencrypted ID. Aggregating incentives into one Barcode 801 is crucial to reducing the amount of time required to extract the relevant information from the Mobile Device 800 by scanning the Barcode 801 with Barcode Scanner 401. The process of aggregating incentives is that of combining all digital information from one or more incentives into one coded image.

Barcode 801 in one embodiment is formed, or coded, using QR code provided by the Denzo-Wave company of Japan.

Barcode Scanner 401 is any coded image reading device (including 2D matrix code scanners) capable of reading the Barcode 801 image off the screen of Mobile Device 800. In further embodiments, Barcode Scanner 401 can be replaced with any data reading device such as RFID interrogators, magnetic card readers, near-field communicators, personal area networking (PAN) devices, sensors, etc. . . . The preferred embodiment of Barcode Scanner 401 is any industry-standard CCD or imaging scanner capable of reading a 2D/matrix barcode. Examples of such imaging scanners include the Honeywell Adaptus 4600, Denso QK11 and the Symbol DS6708.

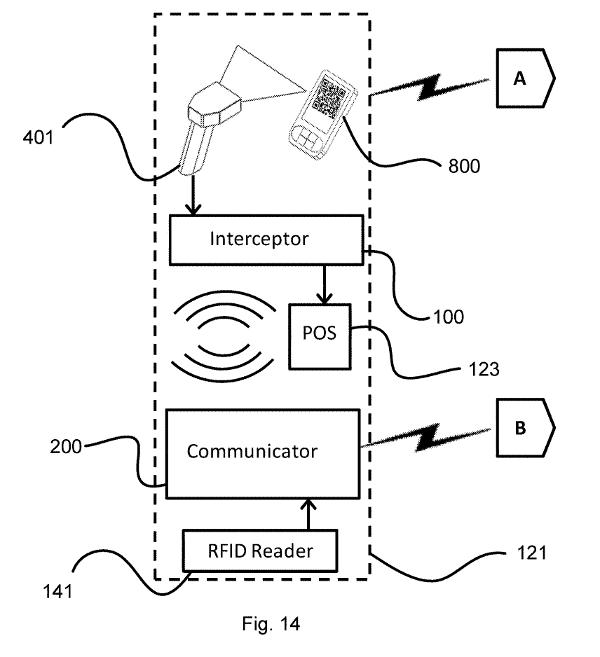

After Barcode Scanner 401 scans the single Barcode 801 displayed on the screen of the customer's Mobile Device 800, the barcode data is sent to Interceptor Device 100 for duplicating, performing operations on selected data, and selectively forwarding/disseminating the resulting data to POS Terminal 123 and/or Communicator Device 200 (as depicted in FIG. 14) (applies to all other data scanned by Barcode Scanner 401, for example a item SKU).

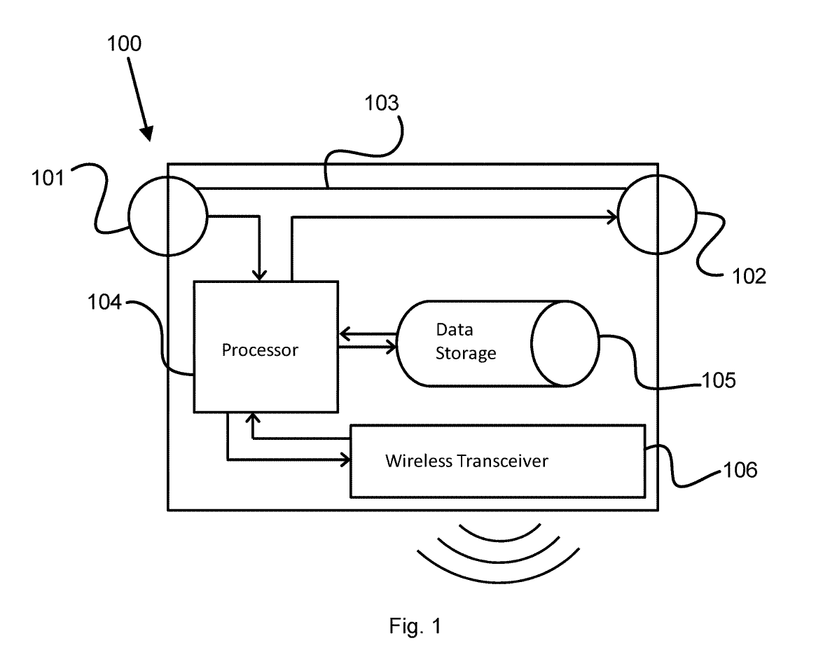

Referring to FIG. 1, the Interceptor Device 100 is comprised of a housing containing Data Input Port 101. In the preferred embodiment of the present invention, Data Input Port 101 receives data from a data reader, such as Barcode Scanner 401 over a Universal Serial Bus (USB) connection. Further embodiments could be a port comprised of PS/2 or RS232 connections, or any other connection method and protocol. The device is further comprised of Data Output Port 102. The device is further comprised of Power Connection 103; in the preferred embodiment of the present invention power is delivered through the connection at Data Output port 102. If a power pin isn't available at Data Output port 102, then an external power adapter is connected or integrated into the device. In further embodiments, power is supplied to any of the operating devices using battery power that is either stored in the same enclosure or outside the enclosure that houses the device. Interceptor Device 100 is further comprised of Data Storage Device 105, used to store data being communicated to Communicator Device 200. The device is further comprised of a Short Range Wireless Transceiver 106 for communicating with one or a plurality of Communicator Devices 200. As one embodiment of the present invention, Short Range Wireless Transceiver 106 is comprised of a Bluetooth transceiver. In further embodiments a ZigBee, WiFi or other wireless transceiver could be used. If Communicator Device 200 is housed in the same enclosure as Interceptor Device 100, Short Range Wireless Transceiver 106 is not needed and Short Range Wireless Transceiver 106 becomes an Input/Output port for direct data transfer with Communicator Device 200. Lastly, Interceptor Device 100 is comprised of Processor 104, an integrated circuit (IC) to process data communications between internal hardware, duplicate data for forwarding/disseminating, and perform operations on data received from Input Port 101 and Short Range Wireless Transceiver 106 by using algorithms stored as device firmware. Such operations include, but are not limited to, disaggregating coded image data, verifying validity of coded data, loading firmware updates, etc.

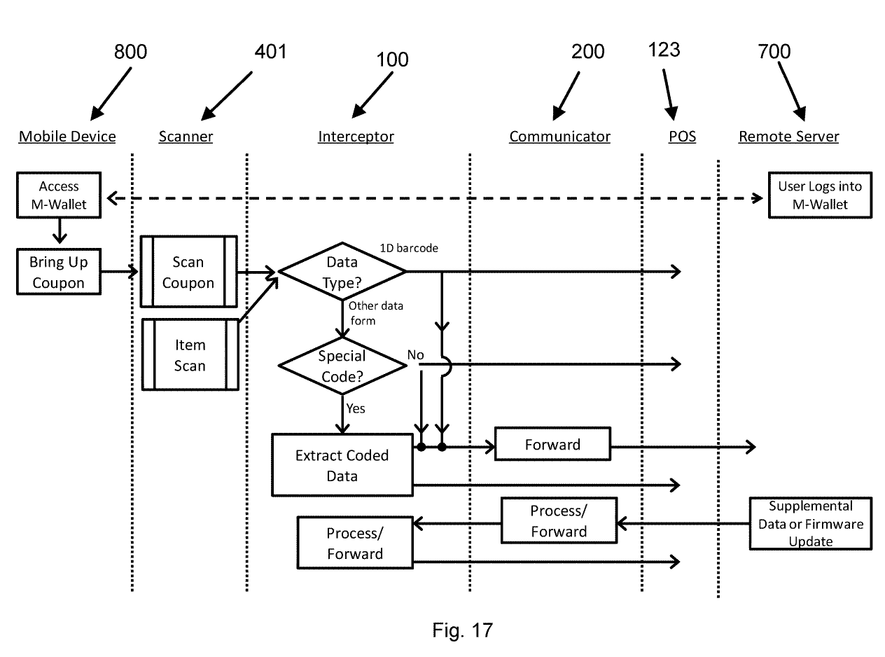

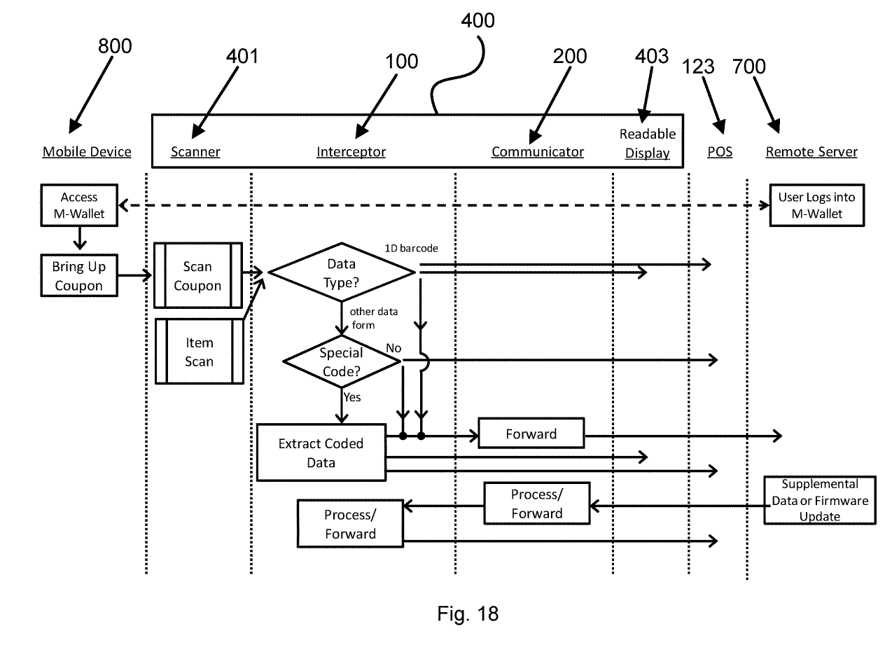

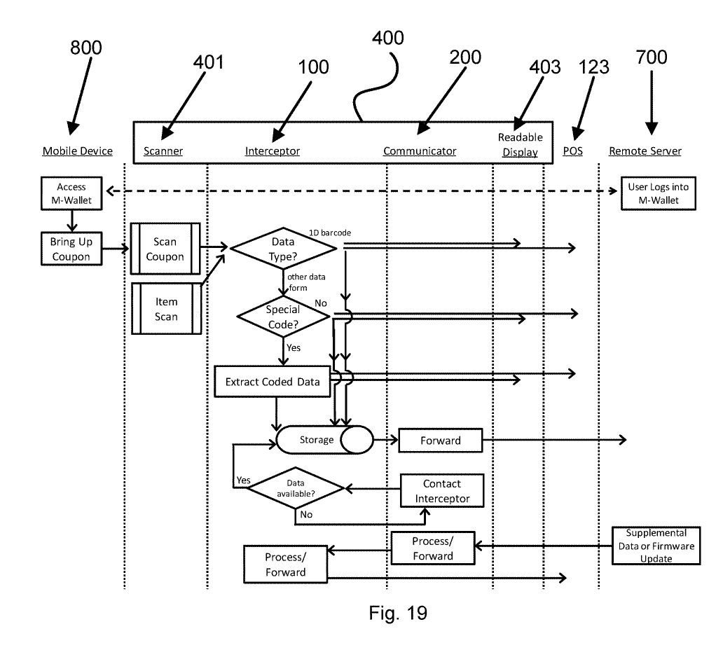

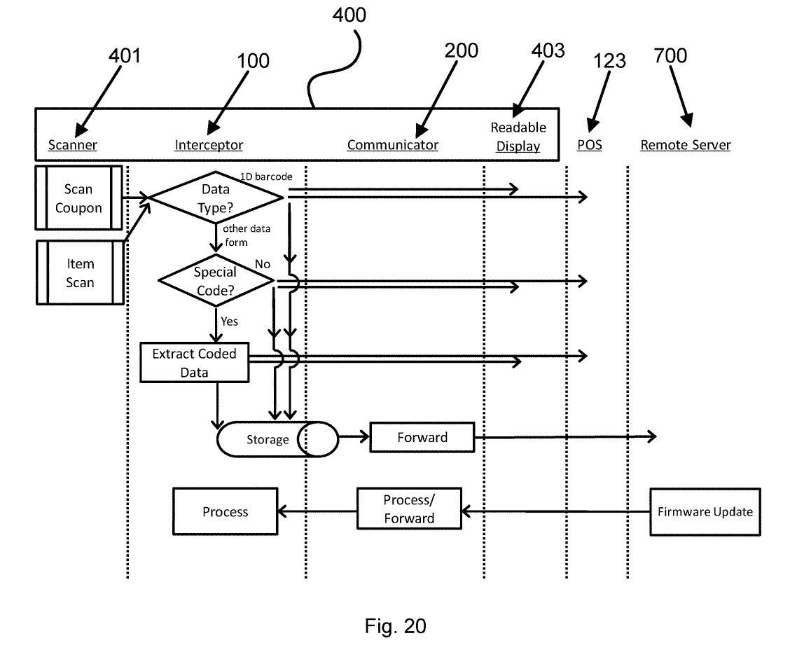

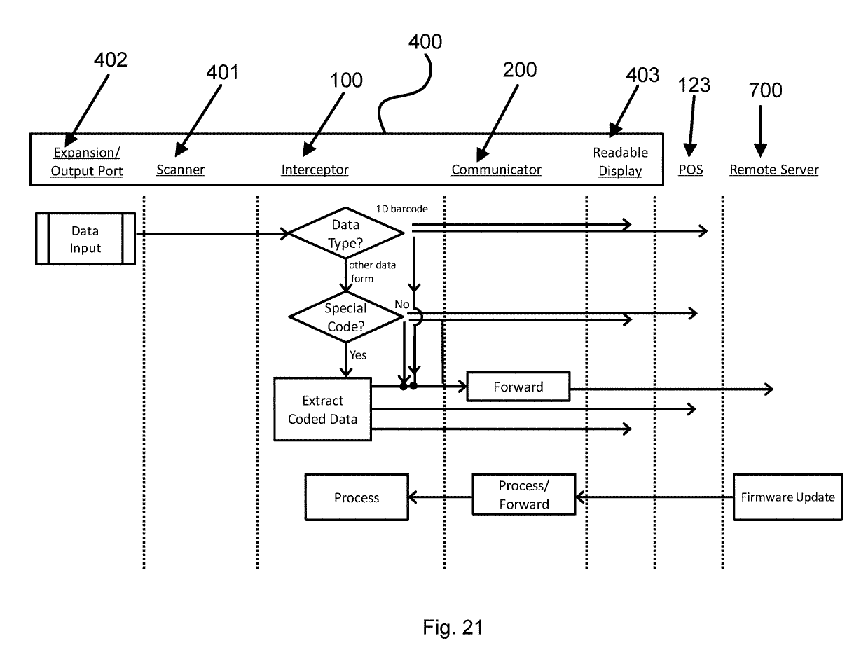

Interceptor Device 100 is placed on-site at the output of a data reader, such as Barcode Scanner 401. Further embodiments have the Interceptor Device 100 placed in series between a data reader and a data utility system, such as POS Terminal 123 (see FIG. 14). In this embodiment, since Interceptor Device 100 is placed in series between Barcode Scanner 401 and POS Terminal 123, all data scanned must pass through Interceptor Device 100. Referring to FIG. 17-21, once data arrives at Interceptor Device 100 it is duplicated and operated on by Processor 104. One embodiment of an operation is determining first if the data is that of a 1D barcode, indicating that the data represents an item's SKU or requires no decoding. If it's determined this is the case, the data is forwarded to any one or combination of the POS Terminal 123, the on-site Communicator Device 200, and Readable Display 403 (as depicted in FIG. 18-21). If it's determined this is not the case, wherein the data is not that of a 1D barcode, it is then determined if the data is associated with a special code. A special code could be that of a set of characters or data format that alerts Interceptor Device 100 to the type of data being scanned from the screen of Mobile Device 800. If a special code is not indicated the data is forwarded to any one or combination of the POS Terminal 123, the on-site Communicator Device 200, and Readable Display 403 (as depicted in FIG. 17-20). If the data is determined to be associated with a special code the coded data is disaggregated into its component parts which might be, but not limited to: coupon IDs, coupon redemption codes, loyalty IDs, encrypted user ID, gift card ID, ticket, etc. This data is selectively sent to any one or combination of POS Terminal 123, on-site Communicator Device 200, and Readable Display 403 (as depicted in FIG. 18-21). In FIG. 21, Interceptor Device 100 is communicating through Expansion/Output Port 402 located on Integrated Interceptor Device 400. Here all data received through Expansion/Output Port 402 is forwarded to Interceptor Device 100. Note that the forwarding of data to Communicator Device 200 is typically completed automatically in real-time. Though with Data Storage Device 105, data can be held and collected until prompted for forwarding (as depicted in FIG. 19). Note that the data forwarded, disseminated by Interceptor Device 100 is processed by Processor 104 such that the data format is matched to the data format required by the receiving device.

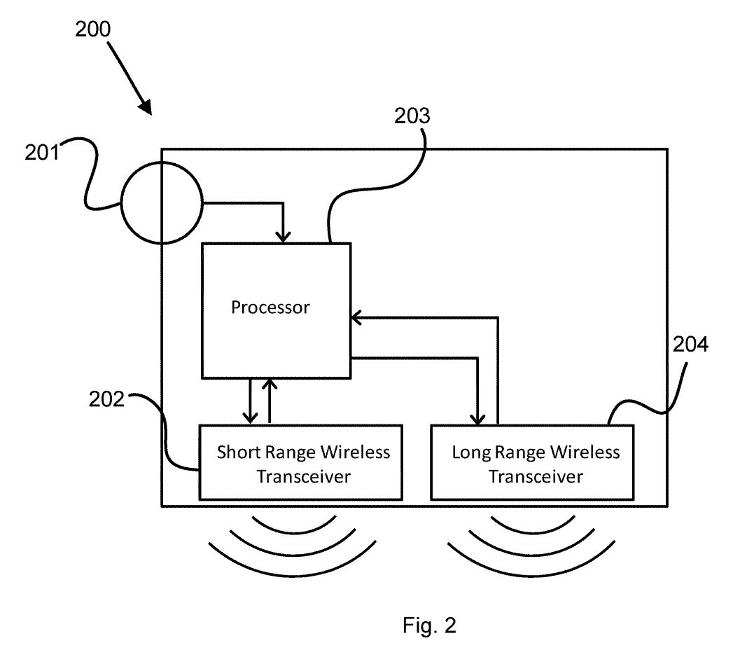

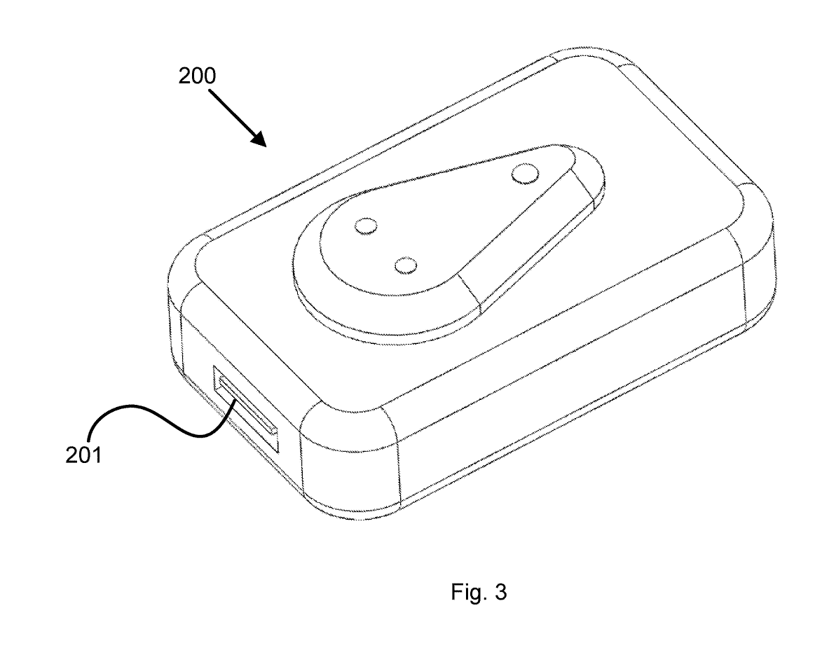

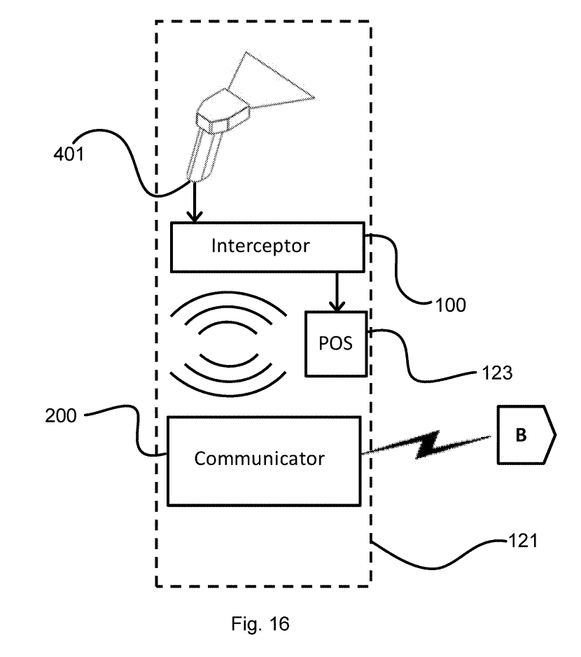

Referring to FIG. 2 and FIG. 3, the Communicator Device 200 is one example of a device means to communicate data. It is comprised of a housing containing an Input Power Port 201 accepting AC or DC voltage. As mentioned earlier, in further embodiments, power is supplied to any of the operating devices using battery power that is either stored in the same enclosure or outside the enclosure housing that device. Communicator Device 200 is further comprised of a Short Range Wireless Transceiver 202 for communicating with one or a plurality of Interceptor Devices 100. If Communicator Device 200 is housed in the same enclosure as Interceptor Device 100, the Short Range Wireless Transceiver 202 is not needed and is replaced by an input/output port that receives data through a wired communication connection. In one embodiment of the present invention, Short Range Wireless Transceiver 202 is comprised the same communication means as Short Range Wireless Transceiver 106, a Bluetooth, Zigbee, WiFi or other wireless transceiver. The device is further comprised of a Long Range Wireless Transceiver 204, the present invention's preferred embodiment utilizes a GSM/GPRS transceiver, in further embodiments CDMA, TDMA or other long range wireless transceivers could be used. Long Range Wireless Transceiver 204 connects wirelessly to a wireless carrier network, ultimately connecting to one or more Remote Servers 700 located off-site (as depicted in FIGS. 11-16). Lastly, Communicator Device 200 is comprised of Processor 203, an integrated circuit (IC) to process data communications between said transceivers. The function of Communicator Device 200 is to send/receive data between a wireless carrier network and one or more on-site Interceptor Devices 100. To eliminate the Communicator Device 200 from the system would require integrating into the Interceptor Device 100 the Long Range Wireless Transceiver 204. Doing so is considered one embodiment of the present invention, resulting in the Integrated Interceptor Device 400.

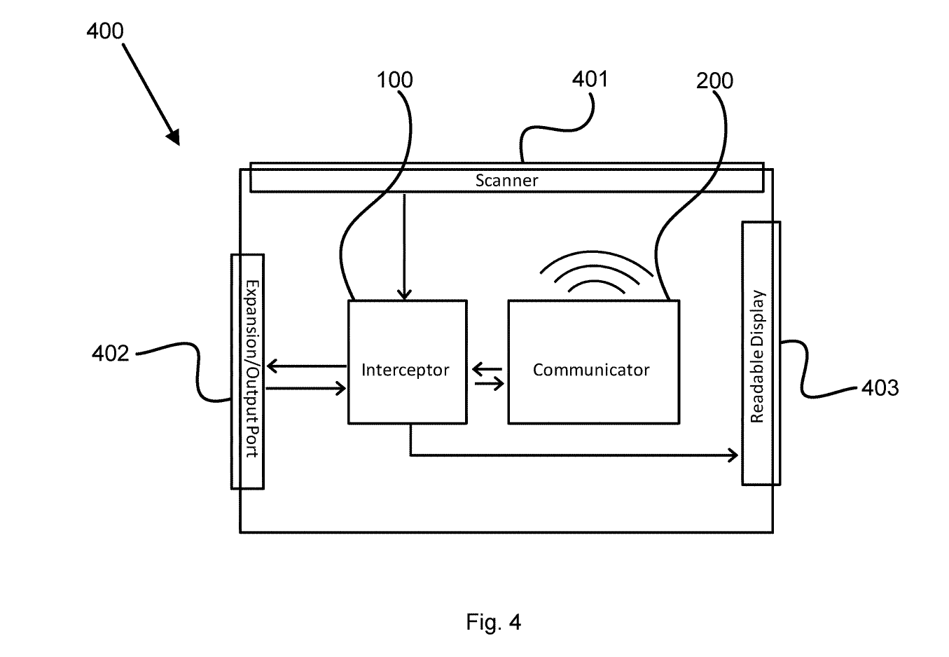

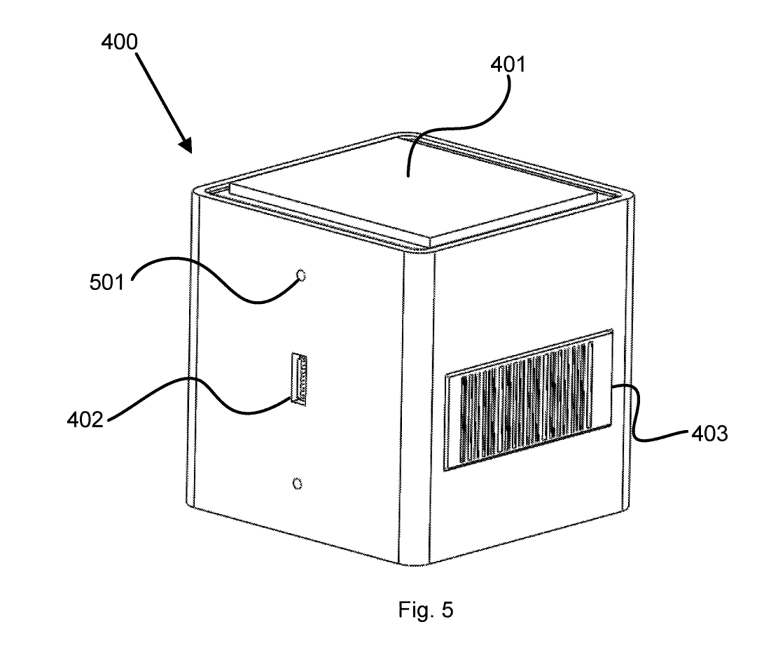

Referring to FIG. 4, Integrated Interceptor Device 400 comprises at least Interceptor Device 100 and Communicator Device 200, and optionally includes Scanner 401 within one enclosure. Further embodiments enclose the three devices in multiple enclosures. As such, Short Range Wireless Transceivers 106 and 202 of Interceptor Device 100 and Communicator Device 200 can be replaced with a direct communications interface. In addition, Integrated Interceptor Device 400 can be comprised of one or more Expansion/Output Ports 402 that can either send or receive data, to and from the Interceptor Device 200 (for example operating as a slave or master USB port). As well, Integrated Interceptor Device 400 can be comprised of one or more Readable Displays 403. A readable display is any device that can display one or more coded images (e.g. a barcode image) and can be scanned/read by scanning equipment that is able to read coded images printed on paper. Examples of readable displays include electronic paper displays configured for displaying barcode images. Readable Display 403 may also be used to display transaction related information (e.g. “coupon valid”, “ticket invalid”, etc) and may also be used to display status information (e.g. “wireless carrier not detected”, “input error xxx”, etc).

FIG. 12 and FIG. 13 depict two embodiments of the communication setup of the Integrated Interceptor Device 400. In FIG. 12, the Integrated Interceptor Device 400 is reading the barcode image displayed on the screen of Mobile Device 800 and is subsequently displaying a barcode image readable by POS Scanner 122. FIG. 13 depicts the same setup, with the addition of Integrated Interceptor Device 400 communicating to POS 123 through a communications cable. Both embodiments are stationed within the walls of Merchant 121. Integrated Interceptor Device 400 is preferably located near POS 123 within easy reach of POS Scanner 122 and Mobile Device 800.

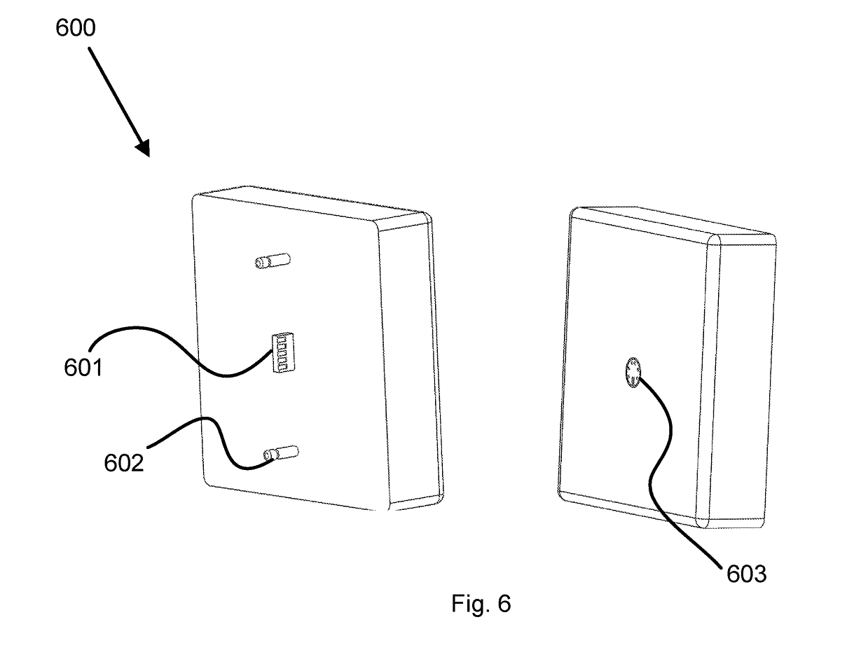

Expansion/Output Port 402 can be utilized as a ‘On the Go’ OTG data port for sending/receiving data to Interceptor Device 100. In one embodiment Accessory Device 600 (as pictured in FIG. 6) can be attached to Integrated Interceptor Device 400 using positive locking (click-in) male and female Mounting Pins 501 and 602, and attaching Communications Port 601 to Expansion/Output Port 402. Other embodiments could use various methods for securing the Accessory Devices to the Integrated Interceptor Device. Accessory Device 600 depicted in FIG. 6 allows a PS/2 connector to plug into PS/2 Receptacle 603, enabling connection to a POS Terminal 123 equipped with PS/2 ports. Further embodiments of Accessory Device 600 provide NFC (near field communications), RFID, and WiFi communications capabilities to Integrated Interceptor Device 400. Without Accessory Device 600 attached, Expansion/Output Port 402 can serve as a USB slave port allowing, for example, a direct data connection to the USB port of POS Terminal 123.

In one economical embodiment there are multiple Interceptor Devices 100 communicating with a single Communicator Device 200, all within a Merchant Store 121 or Site 151. Though in further embodiments there might be just one Interceptor Device 100 per site. Note that Site 151 can be any location where at least one Communicator Device 200 and Interceptor Device 100 are present. A further economical embodiment of Communicator Device 200 is that of a functioning cell/smart phone. Wherein a software application is loaded onto the cell/smart phone that allows the cell/smart phone to function similarly as Communicator Device 200 and/or Interceptor Device 100.

The system can be configured such that the Remote Server 700 can send data or firmware upgrades to either Communicator Device 200 or Interceptor Device 100. Firmware upgrades can modify the functioning of the receiving devices, such as: changing special code formats; halting/enabling device processes; changing device behavior (e.g. Forwarding of data to ports or displays); changing data formats (for received and/or forwarded data), etc.

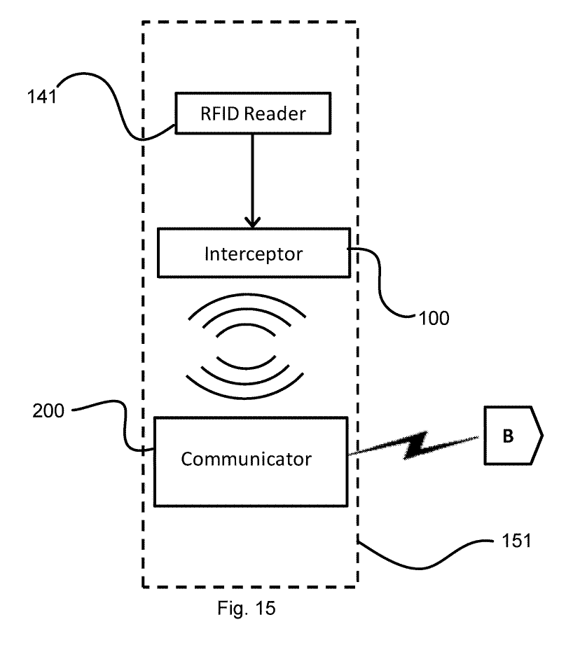

Referring to FIG. 14, an in-store RFID Reader 141 is in communication directly with Communicator Device 200, communicating using Short Range Wireless Transceiver 202. In the present invention's incentive distribution and redemption embodiment, RFID Reader 141 is configured to recognize when the user of Mobile Device 800 is within close proximity to Merchant 121. RFID Reader 141 is preferably able to recognize the user of Mobile Device 800 through an RFID transponder attached or integral to Mobile Device 800, or carried separately by the user. In further embodiments, an RFID transponder might not be representative of a single, unique customer but a customer in general or any item located within Merchant 121. When RFID Reader 141 recognizes a user ID through their associated transponder ID, the user ID is communicated to Communicator Device 200 and forwarded to Remote Server 700. This information is stored and processed by Remote Server 700. In the present invention's preferred embodiment the location data is compared against user information and incentives available by the Merchant 121 or any other incentives not offered by Merchant 121 but located within the same vicinity. At which point the user of Mobile Device 800 might receive incentives in their mobile wallet and made aware of such incentives through SMS, MMS, email, or any other preferred communication medium. In further embodiments, such as depicted in FIG. 15 at least one RFID Reader 141 is setup at Site 151 as a data collection means, wherein people, objects, assets (anything tagged with an RFID transponder) is read by RFID Reader 141 and communicated to Interceptor Device 100 through a wireless connection utilizing Short Range Wireless Transceiver 106 or through a wired connection utilizing Output Port 102. Such a system may be used by a distribution center for tracking inventory flow through an RFID enabled portal. Further uses may include tracking customers as they move around, enter, and exit a location. The same benefits obtained through the use of RFID Reader 141 can be realized by utilizing the Accessory Device 600 in its RFID embodiment.

FIG. 15 shows just one embodiment of a data collection means. Any data reading means can replace RFID Reader 141, such as Barcode Reader 122 or Scanner 401. The figure is depicting an embodiment of the present invention not in communication with a POS system, for example serving the function as an inventory management system.

Referring to FIG. 11, Remote Server 700 is capable of receiving information from multiple sources. To recap sources already defined, one or more Mobile Devices 800 communicates with Remote Server 700 over the mobile device's cellular network. In the present inventions preferred embodiment Mobile Device 800 uses a WAP mobile browser application. Further embodiments do not use an internet browser application, but a software application. Communication is structured around the user interacting with a mobile wallet application hosted by Remote Server 700. Through this application, the user of Mobile Device 800 can organize, add, delete, and modify content within their mobile wallet. As well, they are able to, but not limited to, updating profile settings, privacy controls, and sending coupons and messages to other users of Mobile Devices 800. Remote Server 700 will only push data associated with alerts onto a user's Mobile Device 800 through SMS, MIMS, email, or any other communication medium specified by the user. The system only requires a Mobile Device 800 user to download data to the Mobile Device 800 for display and redemption purposes. Browsing and storage of data is hosted and conducted on Remote Server 700. As such, Mobile Device's 800 memory isn't consumed and the user of Mobile Device 800 isn't charged for unnecessary and expensive cellular network data transfer.

In further embodiments, devices in addition to Barcode Scanner 401 are in communication with Remote Server 700 using Interceptor Device 100 (devices such as card readers, video recorders, payment processing devices, etc). With such a robust network, Remote Server 700 is able to receive in real-time such information as:

mobile wallet user ID (encrypted or unencrypted), Interceptor Device 100 ID, and Communicator Device 200 ID (note that Device IDs can be associated with a specific location)

all UPCs scanned by Barcode Scanner 401 and associated time of scanning

all Coupon IDs, Coupon Redemption Codes, Loyalty Member IDs, Gift Card IDs, and other incentive information

location information regarding the proximity of people or items near RFID Readers 141

payment Transaction information, such as a gift card's credit/debit and balance data

any information converted into data by a data reader connected to Interceptor Device 100 or in direct communication with Communicator Device 200

any 3rd party data, such as user location information obtained through cellular network locating means

Remote Server 700 is able to analyze the above data and provide new incentives to mobile device users, bill advertisers for coupons redeemed, provide inventory flow information, analyze and provide customer profiling information, alert consumers to recalls, provide consumer transaction history (receipts), provide coupon redemption rates, and more. Much of the data will be acted on in real-time; as well the data will be stored in databases for future access.

Mobile Devices 800 outside the walls of Merchant Store 121 are also able to communicate with Remote Server 700. Users of Mobile Device 800 are able to access their mobile wallet application on Remote Server 700 from any location provided a cellular or internet connection exists. Both as the users are moving and stationary, cellular networks and 3rd party data can provide Remote Server 700 with location information of Mobile Device 800 through several means. In the present invention's preferred embodiment Mobile Device 800 is equipped with GPS hardware and services and is able to provided location information. Wherein the location data is communicated to Remote Server 700 through a cellular connection and converted into latitude/longitude coordinates and compared against user information and a catalog of incentives associated with said coordinates. The results are that incentives are chosen automatically for the user and added to their mobile wallet. If desired by the user, an alert is sent to their mobile device through SMS, MMS, email, or any other preferred communication medium specified by the user.

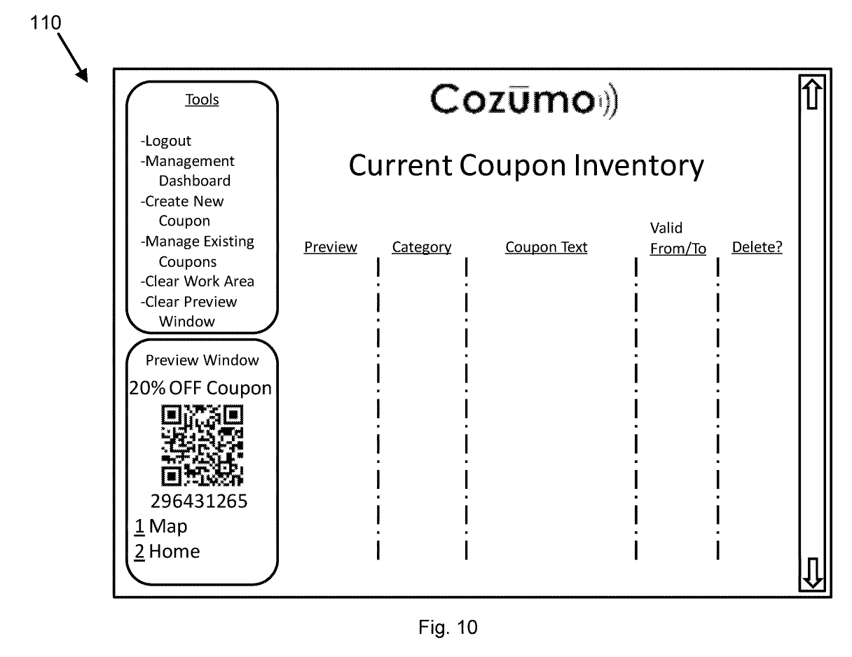

Through internet connections multiple parties are able to add, modify, delete and view information stored on Remote Server 700. Referring to FIG. 11, Mobile Users 113, Advertisers 114 and Merchants 115 are able to access Remote Server 700 through their personal computers. In the case of Mobile User 113, they're able to view the history or prior transactions, manage their mobile wallet, search for incentives, add third party content to their mobile wallet (e.g. venue or transportation tickets), forward incentives to other users, and more. In the case of Advertiser 114, they're able to settle billing, create new incentives, manage existing incentives (as depicted in FIG. 10), analyze customer behavior, determine coupon redemption rates, and more. The graphic user interface (GUI) hosted on Remote Server 700 is customized to a user's needs. For example, a seller of automobiles when creating new incentives would interact with a GUI that is customized for the automobile industry. In the case of Merchant 115, the merchant is able to view all data scanned at their POS terminals 123, determine what users entered and exited their stores, and more. This allows Merchant 115 insight into inventory flow, something desired in POS systems but not available with the dated, legacy POS systems that many merchants are currently using. Transaction data stored on Remote Server 700 will make available to Merchant 115 information regarding what SKU was bought when, by whom and at what POS terminal. Also, Merchant 115 is also able to settle with Advertiser 114 coupon redemption fees, in real-time, by utilizing coupon redemption history available on Remote Server 700.

It is desirable to have an adequate amount of data stored on Remote Server 700 to gain an understanding of mobile device users in order to match them with incentives of most interest. In addition to Remote Server 700 gathering data through Mobile Devices 800 and transactions occurring at Merchant Store 121, the server is in communication with third party data sources such as: credit card transaction data, credit scores, loyalty memberships, locating information, and more. In one example, a mobile device user and their ‘in car’ GPS locating device are associated with each other on Remote Server 700. The third party in control of the data streaming off the GPS device, forwards said data to Remote Server 700, ideally in real-time. In the present invention's preferred embodiment, the location data is converted into latitude/longitude coordinates and compared against user information and a catalog of incentives associated with said coordinates. This action results in incentives being chosen automatically for the user and added to their mobile wallet. If desired by the user, an alert is sent to their mobile device through SMS, MMS, email, or any other communication medium specified by the user. In further embodiments, said streaming location data can be utilized through Remote Server 700 to send alerts to the mobile user of payments due in the near vicinity, traffic warnings, locations of interest, and more.

To register users, the system takes advantage of many of the system resources in place. In the present invention's preferred embodiment, a secure mobile wallet is setup when a potential user sends a short-code message to Remote Server 700 requesting to start the registration process. The user can acquire this short-code message from an advertisement, a peer, a receipt, etc. . . . After receiving the short-code message, Remote Server 700 replies with a SMS message containing a URL registration link to a page on the server. The user activates said link and the registration page is brought up the mobile device's internet browser, at which point the user is prompted to enter their mobile device's phone number and in return they are provided a registration pin number. Remote Server 700 then sends to said phone number an SMS message containing a URL link to their personalized mobile wallet homepage. When the user activates said link they are forced to enter their registration pin to access their mobile wallet for the first time. A similar, but simpler process can be used to setup an unsecured mobile wallet that does not provide sensitive user information. Wherein, after receiving the short-code message, Remote Server 700 replies with a SMS message containing a URL mobile wallet link. The user activates said link and they access their mobile wallet for the first time.

When a new mobile device user or a new advertiser is loaded into the system, incentives may be automatically preloaded to the new or existing mobile device users' mobile wallets. In the example of a new mobile device user signing-up, it is known what location is considered their home position. Associated with that position are latitude and longitude coordinates, which are compared against existing incentives being offered near those location coordinates. Those incentives nearby are loaded automatically into their new mobile wallet. In the example of a new advertiser or new incentive being offered, the incentive's offering location is compared against the location of existing mobile device users. Those users and their mobile wallets located nearby are loaded automatically with the new incentive being offered.

Although the invention has been particularly shown and described with reference to certain embodiments, it will be understood by those skilled in the art that various changes in form and detail may be made without departing from the spirit and scope of the invention.

We claim:

1. A computer-implemented method for processing a barcode image in a point-of-sale system, said method comprising the steps of:
creating a customer specific redemption code, said customer specific redemption code comprising a customer specific barcode and customer specific data;
presenting a barcode image to a data reader;
determining if said barcode image comprises a customer specific barcode;
forwarding said customer specific data from said data reader to an interceptor device if said barcode image comprises said customer specific barcode, otherwise passing said barcode image to the point-of-sale system for processing or redemption;
processing said customer specific data into customer processed data at said interceptor device;
sending select or all of said customer processed data to a communicator device from said interceptor device; and
sending the customer processed data using the communicator device to a remote server for further processing.

2. The computer-implemented method as claimed in claim 1, wherein said customer processed data comprises one or more of a coupon ID, a coupon redemption code, a loyalty ID, an encrypted user ID, a gift card ID or a ticket.

3. The method of claim 1 wherein said further processing comprises sending selected or all of the customer processed data to the point-of-sale system for redemption or other processing.

4. The computer-implemented method as claimed in claim 3, wherein said customer processed data comprises one or more of a coupon ID, a coupon redemption code, a loyalty ID, an encrypted user ID, a gift card ID or a ticket.

5. The computer-implemented method of claim 3, further comprising sending selected customer processed data from said interceptor device, to a readable display device comprising an electronic display device.

6. The computer-implemented method of claim 4, wherein said data reader comprises any one of a barcode scanner, a 2D matrix scanner, a RFID reader, image reader, a sensor, or a card reader.

7. A system for processing a barcode image in a point-of-sale system, said system comprises:
a data reader configured for reading the barcode image and generating a barcode data output;
an interceptor device having an input port operatively coupled to said data reader and configured for receiving said barcode data output;
said interceptor device comprising a processor implemented at least in part in hardware, said processor being configured to determine if said barcode data comprises a customer specific barcode or a conventional barcode, and if said barcode data comprises a conventional barcode, said processor being configured to forward the barcode image to the point-of-sale system for further processing or redemption;
a communicator device operatively coupled to said processor and configured to receive the barcode data from said interceptor device;
a remote server, said remote server being configured to receive data from said communicator device and to transmit data to said communicator device;
said processor being configured to output said barcode data to said communicator device for transmission to said remote server if said barcode data comprises a customer specific barcode; and
said remote server being further configured to process said barcode data received from said communicator device.

8. The system of claim 7, wherein said remote server is configured to analyze said received barcode data and generate one or more of a new incentive to a device for a customer specific redemption code associated with the customer specific barcode, or translate or convert said received barcode data into another format for a device for a customer specific redemption code, generate inventory flow data, generate customer profile data, generate consumer recall alerts, generate a customer transaction history data or generate coupon redemption rate data.

9. The system of claim 7, wherein said barcode data comprises one or more of a coupon ID, a coupon redemption code, a loyalty ID, an encrypted user ID, a gift card ID or a ticket.

10. The system of claim 9, wherein said remote server is configured to analyze said received barcode data and generate one or more of a new incentive to a mobile device for a customer specific redemption code associated with the customer specific barcode, generate inventory flow data, generate customer profile data, generate consumer recall alerts, generate a customer transaction history data or generate coupon redemption rate data.

11. A method to facilitate point-of-sale data processing by presenting to a data reader one barcode image, said method comprising the steps of:
determining if the barcode image comprises a customer specific barcode and includes an aggregation of plurality of data;
displaying the barcode image on a mobile device having a screen;
scanning the barcode image from the screen of the mobile device using an image reader;
forwarding the aggregated data from the image reader to an interceptor device if the barcode image is associated with said customer specific barcode; and
using the interceptor device, disaggregating and disseminating the aggregated data to one or more devices.

12. A device configured to be connected directly in series between a data reader and a POS terminal to enable a data management system that is designed to integrate into current legacy data systems and to further enable real-time viewing and analysis of data, the device comprising:
an interceptor device and a communicator device wherein
the interceptor device comprises,
an input port configured to couple to a data output port on the data reader and input reader data generated by the data reader in a native format;
a processor implemented at least in hardware, said processor being configured to determine if said reader data in its native form comprises a customer specific code;
a communicator device, said communicator device being configured for communication with said interceptor device;
said processor being configured to forward the reader data in its native form to the communicator device if said reader data comprises the customer specific code, otherwise said processor being configured to forward said reader data in the native format to the POS terminal; and
wherein the data management system comprises a remote server, said remote server being configured to receive said reader data, said remote server being configured to process said reader data.

13. The device of claim 12, wherein said remote server is configured to analyze said received reader data and generate one or more of a new incentive to a mobile device for a customer specific redemption code associated with the customer specific barcode, generate inventory flow data, generate customer profile data, generate consumer recall alerts, generate a customer transaction history data or generate coupon redemption rate data.

14. The system of claim 12, wherein said barcode data comprises one or more of a coupon ID, a coupon redemption code, a loyalty ID, an encrypted user ID, a gift card ID or a ticket.

15. The method of claim 1 wherein said further processing comprises sending data from said remote server to said communicator device or to said interceptor device, wherein said sent data comprises an invalid incentive redemption.
